(19) United States
(12) Patent Application Publication
(10) Pub. No.: US 2017/0085538 A1
(43) Pub. Date: Mar. 23, 2017

(54) CUSTOMIZABLE COMPUTERIZED ACCOUNTING INFORMATION SYSTEM AND METHODS OF PROCESSING AND SECURELY EXCHANGING ACCOUNTING DATA

(71) Applicant: Daniel A. Dooley, Hull, GA (US)

(72) Inventor: Daniel A. Dooley, Hull, GA (US)

(21) Appl. No.: 15/371,169

(22) Filed: Dec. 6, 2016

Related U.S. Application Data
(63) Continuation-in-part of application No. 13/874,476, filed on Apr. 30, 2013, now Pat. No. 9,544,284.
Application No. 13/874,476 is a continuation-in-part of application No. 13/560,528, filed on Jul. 27, 2012, now Pat. No. 9,378,026.
Application No. 13/560,528 is a continuation-in-part of application No. 14/593,438, filed on Jan. 9, 2015.
Application No. 14/593,438 is a continuation-in-part of application No. 13/560,528, filed on Jul. 27, 2012, now Pat. No. 9,378,026.
Application No. 13/560,528 is a continuation-in-part of application No. 15/164,346, filed on May 25, 2016.
Application No. 15/164,346 is a continuation of application No. 13/560,528, filed on Jul. 27, 2012, now Pat. No. 9,378,026.

(51) Int. Cl. H04L 29/06; G06Q 10/06

(52) U.S. Cl. CPC H04L 63/0435; G06Q 10/06; G06Q 2220/10

(57) ABSTRACT

The present disclosure describes various embodiments, as well as features and aspects thereof, of a computerized accounting information system that is configured to receive data entries relating to various transactions and to comply with various accounting standard. The computerized accounting information system is also configured to receive, analyze, and securely exchange data entries for a variety of types of data fields that comply with a variety of accounting standards. In another exemplary embodiment, the system is configured for dimensional accounting by allowing for the specification and use of multiple accounting standards/dimensions categories. In another exemplary embodiment, the system is configured implements a technique for the secure exchange of data between multiple business entities/end-users that use compatible business management systems.

### CROSS-REFERENCE TO RELATED APPLICATION

This application is also related to co-pending U.S. utility patent application with application Ser. No. 13/874,476 entitled “SECURE DATA EXCHANGE TECHNIQUE”, filed on Apr. 30, 2013, and having attorney docket number 20071.1031, which is a continuation in part of application Ser. No. 13/560,528 entitled “CUSTOMIZABLE APPLICATION”, filed on Jul. 27, 2012, and having attorney docket number 20071.1010, both of which are entirely incorporated by reference herein. This application is also related to co-pending U.S. utility patent application with application Ser. No. 14/593,438 entitled “COMPUTERIZED ACCOUNTING INFORMATION SYSTEM AND A METHOD OF PROCESSING ACCOUNTING DATA”, filed on Jan. 9, 2015, and having attorney docket number 20071.1050, which is a continuation in part of application Ser. No. 13/560,528 entitled “CUSTOMIZABLE APPLICATION”, filed on Jul. 27, 2012, and having attorney docket number 20071.1010, both of which are entirely incorporated by reference herein. This application is also related to co-pending U.S. utility patent application with application Ser. No. 15/164,346 entitled “CUSTOMIZABLE APPLICATION”, filed on May 25, 2016, and having attorney docket number 20071.1011, which is a continuation of application Ser. No. 13/560,528 entitled “CUSTOMIZABLE APPLICATION”, filed on Jul. 27, 2012, and having attorney docket number 20071.1010, both of which are entirely incorporated by reference herein.

### BACKGROUND

The present disclosure relates to a system and method for data management and, more particularly, to an improved computerized accounting information system and a method of processing accounting data.

The significant advancements in data measurement, collection and management of the past century have made obtaining relevant and competent data relatively easy and inexpensive. Despite the obvious benefits, one result of this copious data intake and easy-access is the creation of a new burden on data collectors. It is well known that data is worthless if it is not organized, packaged, processed, and presented in a manner that allows the user to distill meaning, extrapolate inferences, and find pertinent data, effectively and efficiently. Consequently, business data management software and computerized accounting information systems have become a ubiquitous tool for holding, organizing, and facilitating the analysis of vast amounts of data.

Business management software generally takes the form of a digital database that stores discrete datum points, organizes the datum points into fields (to distinguish certain types of datum from other types of datum) and provides analytical tools (e.g., arithmetic and statistical) for the analysis of the data. Business management software may have many other additional features.

In particular, business management software is very beneficial for the field of financial accounting, which relies heavily on analyzing vast amounts of financial accounting data. Financial accounting data is generally vast because of the nature of the accounting practice itself. Accounting relies on a thorough collection and analysis of all transactions over a fixed period of time. A plurality of different financial documents, based on the accounting data, tell the financial story of a financial entity over that period of time and provide insight into how the financial entity is doing (as compared to the past) and how the financial entity is projected to do in the future (based on data previously collected). This story includes an assessment of the cash flows, debts, accounts receivable, liabilities, equities, incomes, losses, taxes, etc. In the end, the plurality of different financial documents must be reconciled so as to make sure that there are no missing/incorrect points of datum, which could skew any analysis results, and that all applicable laws governing financial accounting have been followed. This is where the business management software becomes most useful.

However, financial accounting data is especially unique in that it is typically a combination of empirical information (e.g., monetary values and tax percentages) and non-empirical judgment characterizations. For example, a financial accountant compiling financial accounting data for a specific financial entity must generally follow a specific accounting standard for each jurisdiction in which they have to produce financial documents. The reason being that many jurisdictions (typically, different nation-states) have different tax rates, different laws governing the characterizations of different financial transactions and, sometimes, different generally accepted accounting principles. Therefore, even though the same empirical information is coming into the business management software, that empirical information may be characterized differently by the financial accountant depending on the particular accounting standard being followed.

Furthermore, modern business management software—in the form of a computerized accounting information system—usually takes the form of network applications. The advent of network applications, in many ways, has changed the business management software field. In network applications, a user utilizing either a client system or a web browser software package may access the network application over an internet connection, connecting the user's client with an application server. Two huge impacts were realized with the move towards network applications. One was the near annihilation of having to distribute business management software via various media and physical delivery, and another impact was the ease in updating and maintaining the business management software. Rather than having to redistribute new versions of the business management software, the computerized accounting information system can be updated on an internet server and subsequent invocations of the system automatically operate the updated version.

### SUMMARY

The present disclosure describes various embodiments, as well as features and aspects thereof, of a business management system in the form of a computerized accounting information system. More specifically, one exemplary embodiment of a computerized accounting information system comprises a data entry module, a command receiving module and a processing module. The computerized accounting information system is configured to receive data entries relating to various transactions and to comply with various accounting standard. The computerized accounting information system is also configured to process a method comprising the actions of receiving, analyzing, and securely exchanging data entries for a variety of types of data fields that comply with a variety of accounting standards. In this way, the computerized accounting information system can more efficiently and effectively process accounting data entries and produce analytical financial accounting actions.

In this way, the computerized accounting information system of the present disclosure helps deal with a common issue prevalent in presently available business management software. In particular, presently available business management software in the accounting field is significantly less useful than in other fields for the following two reasons.

First, because of the existence of different accounting principles, a financial accountant must generally use different and discrete business management software records for each accounting principle governing the characterization of that financial entity's accounting data. Second, to go along with each of these different and discrete business management software records, the financial accountant must generally keep a log of the rational behind the judgment characterizations made by the financial accountant under each accounting standard. This log is needed because it is difficult for the financial accountant to keep track of each specific judgment characterization for each specific accounting standard for each specific datum point. Moreover, it is not uncommon for the jurisdictions to make significant changes to the accounting standards throughout the life of a financial entity. This results in financial accounting data records for a specific financial entity wherein one range of data records under a specific accounting standard have different rationales for the judgment characterizations than another range of data records under that same specific accounting standard. Luckily, the computerized accounting information system of the present disclosure helps resolve these issues as is explained in more detail herein.

In another exemplary embodiment, the business management system does not make judgment characterizations under each accounting standard like a human financial accountant (which requires learned rationales, for example). Nonetheless, the accounting standards handled by the business management system may have certain elements/computations caked in, which are well known, stable, and capable of machine processing. As such, via modern machine learning algorithms, those portions of the accounting standard may be characterized by the computerized accounting information system, and the well-known, formulaic, and established rules may be leveraged by the computerized accounting information system to evaluate/parse/process business data to find discrepancies, for example. Moreover, the computerized accounting information system may be configured to do auto-complete functions for those portions of the accounting standard(s) as well as various other functions described herein.

In another exemplary embodiment, the business management system gives an end user the ability to apply what is sometimes known in the field as dimensional accounting. In particular, the business management system allows for the specification and use of multiple accounting standards/dimensional categories. A dimensional accounting transaction may consist of multiple standard/dimension sets that allow the classification of a single piece of data across multiple collections of differing accounting criteria/judgment characterizations. For example, in one non-limiting example, a single transaction may produce one datum point that is recorded differently under different dimensions and reported on in different/disparate ways, while still representing only one transaction.

In this way, the business management system of the present invention may operate as a computerized accounting information system that presents organized intepretations/judgment characterizations of gathered accounting information/data. The computerized accounting information system may operate as a tool that provides semantic information, that is, information about the relation between the gathered information and generally recognized accounting standards or “concepts.” The computerized accounting information system may, therefore, also operate as a taxonomy(ies)—a description and classification system for the concepts.

Within the computerized accounting information system, one exemplary data structure envisioned comprises two primary components. The first is a set of fields (referred to as “tags” or “concepts”) that are associated with a transaction record. Each transactional record may have a different set of tags/concepts for as many taxonomies that are handled by the system. The second component is a mechanism by which output is generated and transmitted to the various client applications/invocations of the system. This output is delivered in the format defined by a user-specified taxonomy, for example.

In another exemplary embodiment, the business management system allows for the use of a single system with entered/collected data to support various applications beyond simply accounting. For instance, taxonomies (described in greater detail herein) can be set up for risk management, environmental monitoring, etc. and handled by the system. Data collected at least for purposes of the accounting field can be correlated from the accounting taxonomy to another. For instance, purchases and sales transactions, important to the accounting functions of the system, entered/collected via the system can also be accessed by other taxonomies as supportive data. In one non-limiting example, a manufacturing company/entity using the business management system may get energy credits based on certain purchases and sales. If the manufacturing company purchases a certain kind of product, that purchase can be recorded by the system for the accounting taxonomy as a purchase but, then the model number data can be read in by the environmental taxonomy to determine if energy credits are due and the environmental taxonomy can track and report an accounting of energy credits. Various other uses and embodiments are envisioned.

Furthermore, the present disclosure describes various embodiments, as well as features and aspects thereof, of a computerized accounting information system that can include customized functionality that can be selectively enabled without disrupting the underlying operation of the business data management system or requiring multiple instances or versions of the system/software that must be separately stored and maintained. More specifically, one exemplary embodiment of a computerized accounting information system is generally made available over a network for various users. A feature is provided that allows users to selectively activate one or more customized or specialized functions and/or features of the application such that the user gains access to a customized operation of the application without the application provider having to separately create and maintain multiple versions of the web application.

Furthermore, the present disclosure describes various embodiments, as well as features and aspects thereof, of a computerized accounting information system that implements a technique for the secure exchange of data between multiple business entities/end-users that use compatible business management systems. More specifically, one exemplary embodiment of a computerized accounting information system utilizes serializable data transfer objects to transfer business/accounting data over a secure communication path. This eliminates the need for an active user connection between entities needing to exchange business/accounting data. The data contained within the transfer objects can be used by any participating entity to update existing records related to the transaction, or to create new records relating to the transaction. Serializable objects link all data relating to a given business transaction. An interface allows users to view data contained in or referenced by an object, and to create or modify transaction records based on the data.

In another exemplary embodiment of the computerized accounting information system, the system is characterized by the provision of a web-based application or web-centric application that includes customized features or aspects, which can be individually and selectively enabled by a user of the application client accessing such web based applications without requiring the computerized accounting information system provider to maintain and track multiple versions of the web-based applications and/or the application clients accessing or running in conjunction with the web based application. In general, by simply providing the ability for the user of the application client to selectively enable or disable custom features or aspects of the application, the software provider can update the application to include customized features, instruct the user on how to access the features, and then if the features are accessed by a user, the software provider can, if so desired, charge a premium for the use of the customized features.

In this way, the computerized accounting information system of the present disclosure helps resolve a prevalent issue in the field, namely, customization of the business accounting data management system for a particular business/industry. Just like any mass-produced and/or distributed market, customization either cuts into the profits or requires a price increase. In the software industry, this phenomenon exits for media delivered applications as well as web based applications. In the field today, to provide customized network applications, multiple instances of the application must exist, be maintained, and utilize server storage and processing resources. As a solution, the computerized accounting information system of the present disclosure provides customized features for application clients that can alleviate the maintenance issues involved in maintaining multiple versions of customized applications.

Furthermore, one non-limiting exemplary embodiment presented in the disclosure is a solution that provides a web-based application that is executed on an application client and that can include customized functionality without disrupting the underlying operation of the web-based application or the application client, and alleviating some of the requirements for maintaining and supporting multiple instances or versions of the web application. Initially, a user can access a web-based application utilizing an application client, by invoking the application over the internet or some other network to connect with a specified server housing one or more components of the web-based application. Once invoked, some of the business logic required to run the application can be loaded into the application client from the server.

Initially, the user of the application client executes the application by invoking it on the user's computer. This invocation results in the operating system then invoking a JAVA virtual machine which loads and runs the application. Once the application is loaded, such as by loading components from the application client, the server or a combination of both, the application then loads the business logic. Once the business logic is loaded and any pertinent data is retrieved from the server, the application client can render the application content which typically includes graphical user interface screens with various data fields, function keys, etc. The user can then interact with the application client on their own machine by actuating function keys, entering or modifying date, or the like. The actuation of the function keys and/or entering data can invoke further interaction with the server in which commands or modified data is transferred from the application client to the server. One of the functions that can be included in the rendering of the application to the user is the ability to activate a customized function. The customized function may be a function that others have caused to be created and is now accessible to other users or, it may be a function that the user has requested of the application provider.

In operation, the user can activate the function by providing an indicator, such as selecting what is referred to in this description as a logic key. When the server receives the commands and/or data from the application client, if the logic key is enabled, the server can operate to load new business logic into the application client to implement the functionality associated with the logic key. Thus, it will be appreciated that such a technique allows the application provider to offer customized or enhanced functionality to a user of the application while still maintaining the standard functionality of the application for other users. Further, the application provider only has one version of the web-based application to maintain as all of the business logic to be loaded into various application clients can be included within the server and selectively loaded to application clients based on the presence or absence of logic keys being enabled or selected.

The add-functionality can be quite varied. In some embodiments, the added functionality may be utilized to enable a feature that is available throughout the application. In other embodiments, the feature may only operate on a certain limited area of the application. For instance, a non-limiting example of such a feature may result in the need to create additional data fields for storing, sorting and housing user data. In such an embodiment, the business logic, once loaded into the application client, can result in the modification of the look and feel of the rendered application from the user's view, and/or create additional data fields to be stored in a database accessed by the server supporting the web-based application and communicating with the application client.

For instances in which a user desires a customized feature, the user can provide a functional description of the feature to the application provider or, the functional description could be provided by others including the application provider itself. The application provider/manager can then create the software or algorithm and/or business logic necessary to perform the defined functions or provide the described feature. When the business logic subsequently gets loaded into the application client, the business logic can include the new algorithm, if and when the user enables the added-functionality.

Even further, the customization of the functions or features provided to users of the application can be further granularized by allowing the user to not only enable add functionality, but also to provide parameters that can control aspects of the operation of the function. In some embodiments, certain features and functions can be made available to all users, whereas in other embodiments, features and functions may require a user to send credentials or have credentials examined to determine if the user can access the features and functions of the application. In yet other embodiments, a mixture of both types of features and/or functions can be provided, open access functions and those that require certain credentials. Further, the features and/or functions may also, when enabled, trigger the increase in fees charged for the use of the application. Similarly, by disabling such features and/or functions, the fee for use of the web-based application can be decreased.

In another exemplary embodiment of the computerized accounting information system, the system is characterized by a novel technique for securely exchanging electronic accounting data between multiple entities that share a common accounting link and that utilize the same business management system, without compromising the confidential or otherwise unauthorized data of any of the entities. In one non-limiting example, the technique utilizes data transfer objects that can be serialized. The serialized data transfer objects are used to share business data over a secure communication path, eliminating the need for an active user connection between entities wishing to exchange data. The data contained within the transfer objects can be used by any participating entity to update existing records related to the transaction, or to create new records relating to the transaction. Security of business data between the participating entities is maintained both because there is no remote user connection between any of the participating entities, and because the participating entities have the option of accepting or not accepting the data being exchanged into their business management systems. In addition, a comprehensive audit trail of records relating to the transaction is created.

The secure data exchange technique can be utilized in a variety of business settings and computing environments. As a non-limiting example, it can be part of a web-based or web-centric accounting and general ledger system in a client-server configuration. One implementation of the technique contains a user interface in the client module that sends information to the server and receives information requests from the server, and a server module that receives information requests from the client and sends information to the client. Data relating to a business transaction to be exchanged is organized into a serializable transfer object, which is then transmitted over a secure communication path to the other participating entity or entities. The data contained in the transfer object can be accessed by users of the participating entities and used to update their own existing records relating to the transaction, or create a new record relating to the transaction. Because the transfer object is serializable, whenever any of the participating entities creates a new record or modifies an existing record relating to the transaction, the transfer object is modified with the data contained in the new or modified record. The result is that the transfer object contains and maintains a comprehensive documentation “chain” of all the data relating to a business transaction that can be accessed by any of the entities participating in the transaction.

In general, embodiments of the secure data exchange technique operate to share business data related to a given transaction between participating entities by using data transfer objects to link the data contained in the business records of each participating entity. In this way, the computerized accounting information system of the present disclosure helps resolve prevalent issues in the field, namely, the cost of conversion software, the cost conversion services, or both. Additionally, the purchase of readily available computerized accounting information systems may require a user business entity to update or replace some or all of its hardware. Another obstacle is that many small business users do not have dedicated IT employees with the knowledge or expertise to handle a data integration project. Another obstacle is the preparation and training for the new technology, which can be so disruptive to the daily operations of a small business user that current revenue and customer relationships may be adversely affected. Obstacles like these as well as others, even if only perceived, can make small business user very reluctant to undertake data conversion projects, regardless of how affordable or seamless their implementation might actually be. Luckily, the computerized accounting information system of the present disclosure helps resolve these issues.

Various embodiments, configurations, features and aspects of the computerized accounting information system and the method of processing accounting data are described in more detail in the detailed description with reference to the attached drawings.

### BRIEF DESCRIPTION OF THE SEVERAL VIEWS OF THE DRAWING

FIG. 1 is a functional block diagram of the components of an exemplary environment or platform in which various embodiments of a computerized accounting information system and a method of processing accounting data may be implemented.

FIG. 2 is a functional block diagram of one exemplary embodiment of a computerized accounting information system.

FIG. 3 is a functional block diagram of one exemplary embodiment of a functional environment in which a computerized accounting information system can be implemented.

FIG. 4 is a block diagram of the components of an exemplary web server residing in a J2EE based architecture.

FIG. 5 is partial view of an exemplary screen structure selected from many available screen structures for a computerized accounting information system

FIG. 6 is a conceptual diagram of one exemplary embodiment of an implementation of the server side logic of the exemplary web server residing in a J2EE based architecture.

FIG. 7 is a table showing the allocation of funds received into the organization as cash transactions for Example 1.

FIGS. 8-22 are exemplary balance sheets that can be automatically generated by the computerized accounting information system for an account that is marked with the virtual account added functionality of Example 1.

FIG. 23 is a block diagram of the exemplary use of a secure communication path between participating entities implementing the computerized accounting information system.

FIG. 24 is a conceptual diagram of the components of an exemplary data transfer object for a client-server object oriented architecture.

FIG. 25 is a conceptual diagram illustrating the concept of object serialization for a client-server object oriented architecture.

FIG. 26 is a block diagram of an exemplary embodiment of a business management system/computerized accounting information system of participating entities Company A and Company B, and the secure communication path between the two entities.

FIG. 27 is a flow diagram of the contents of an exemplary DTO as participating entities access and modify it during an exemplary business transaction handled via a business management system/computerized accounting information system.

FIG. 28 is a partial view of an exemplary screen structure of a conceptual user interface selected from many available screen structures in a computerized accounting information system.

FIG. 29 is a flowchart diagram illustrating a first set of actions that may be implemented by the various embodiments of the computerized accounting information system of the present disclosure, or that may be included within a method of processing accounting data.

FIG. 30 is a flowchart diagram illustrating a second set of actions that may be implemented by the various embodiments of the computerized accounting information system of the present disclosure, or that may be included within a method of processing accounting data.

FIG. 31 is a flowchart diagram illustrating a third set of actions that may be implemented by the various embodiments of the computerized accounting information system of the present disclosure, or that may be included within a method of processing accounting data.

FIG. 32 is a flowchart diagram illustrating a fourth set of actions that may be implemented by the various embodiments of the computerized accounting information system of the present disclosure, or that may be included within a method of processing accounting data.

FIG. 33 is a flowchart diagram illustrating a fifth set of actions that may be implemented by the various embodiments of the computerized accounting information system of the present disclosure, or that may be included within a method of processing accounting data.

FIG. 34 is a flowchart diagram illustrating a sixth set of actions that may be implemented by the various embodiments of the computerized accounting information system of the present disclosure, or that may be included within a method of processing accounting data.

FIG. 35 is a flowchart diagram illustrating a seventh set of actions that may be implemented by the various embodiments of the computerized accounting information system of the present disclosure, or that may be included within a method of processing accounting data.

FIG. 36 is a screenshot of one exemplary embodiment of an end-user interface 1000 as it might appear to an end-user.

### DETAILED DESCRIPTION OF VARIOUS EMBODIMENTS

The following written description explains various embodiments of a computerized accounting information system and a method of processing accounting data. Various embodiments, as well as features and aspects that may be incorporated into some embodiments, are presented in this description. In general, some embodiments may be direct towards an accounting system, or other data entry system that allows a user to enter data based on multiple criteria—such as different accounting standards. The user can thus keep track of multiple transactions entered in compliance with different accounting standards. In addition, reports, analysis or other actions can be performed with this single accounting system, based on any of the accounting standards supported by the data entry.

This written description refers to the appended drawings to supplement the written explanation. As such, the written words should not be construed as limitations. Numerous specific details are explained in the written description and depicted in the drawings to provide an enabling understanding of the various embodiments to one having ordinary skill in the art. Some details, however, need not be expressly explained because they would be readily apparent and understood by one having ordinary skill in the art. For example, certain described embodiments and explanations of some specific details are omitted so as to not unnecessarily obscure the written description. Additionally, one having ordinary skill in the art would understand that the various embodiments might be practiced without some or all of these specific details.

For purposes of this disclosure, the term web-based application will be described as an application client that runs or executes an application but that initially obtains one or more components for the application from a server or servers that are accessed via a network, such as the World Wide Web or some other network including local area networks, wide area networks, or the like.

A person of ordinary skill in the art understands that taxonomies are obtained when several fundamental divisions of gathered information are considered in succession, rather than simultaneously. Generally speaking, a taxonomy is obtained when a narrow set of procedures and rules are applied to gathered information for the purpose of (1) describing/labeling the information and (2) producing classifications based on the relation between the gathered information and the general “concepts.” For purposes of a taxonomy, a “concept” (like an accounting standard) refers to the user/creator of the taxonomy's arbitrary and subjective understanding of a set of information and how individual information points within the set are or are not like other individual information points.

Furthermore, a taxonomy may be more clearly defined as an ordered classification system where information is grouped, like with like, according to presumed natural relationships such that the structure of the taxonomy is consistent with a user's/creator's conceptualization of the subject of the information. As such, a taxonomy is not simply a neutral structure for categorizing the information; instead, it implicitly embodies the user/creator of the taxonomy's theory of how the individual information points operate and relate to one another, as well as to other types of information.

A well-known example of an implemented accounting taxonomy is the XBRL taxonomy. The XBRL taxonomy is a particular way to describe and classify accounting reporting concepts. XBRL represents each concept as an element with a name. The XBRL US GAAP Taxonomy describes and classifies elements representing US GAAP reporting concepts. XBRL taxonomies are electronic, machine-readable “dictionaries” consisting of many linked files containing thousands of elements linked to each other. The taxonomy contains human-readable labels such as financial statement line item captions, definitions, and applicable authoritative references for each element.

The XBRL US GAAP Taxonomy is based on generally accepted accounting principles in the United States and is intended for SEC registrants who file financial reports prepared in accordance with US GAAP. The XBRL US GAAP Taxonomy has broad and deep coverage of financial reporting concepts including all US GAAP and SEC financial statement disclosure requirements and many elements for commonly followed reporting practices. The taxonomy's size and breadth minimizes the effort required to extend the taxonomies to meet specific reporting needs.

Although throughout the detailed description the various embodiments are directed towards a computerized accounting information system and a method of processing accounting data, it should be understood that the focus of such description is only to ensure clarity in the configuration and operation of the various embodiments. The description should not be used to limit the usefulness of the various embodiments in other manners or for other uses.

Embodiments and aspects of the present invention provide a computerized accounting information system, and a method of processing accounting data, that can more efficiently and effectively process accounting data entries, for various types of data fields, that comply with various accounting standards and produce analytical accounting actions. More specifically, the system or method is configured to give an end-user quick and simple access to accounting data entries, which have been characterized by various accounting standards, without the need for disparate data records or out-of-system explanatory logs for the accounting standard characterizations. Furthermore, the system or method is configured to leverage these data entries produce accounting standard specific analytical accounting actions that include the production of reports, tax returns and other similar financial statements known to one having ordinary skill in the art.

To secure the communication path, a protocol such as HTTPS can be utilized as a non-limiting example. HTTPS, which is an acronym for Hypertext Transfer Protocol over SSL, is a protocol utilizing TCP to transfer hypertext requests and information between servers and browsers. When HTTP utilizes SSL, which is an acronym for Secure Socket Layer, or TLS (Transport Layer Security), the protocol is referred to as HTTPS. Thus, in the illustrated example, communication between the application client 110 and the server 120 is conducted by a combination of hypertext transfer protocol and SSL/TSL. The use of this protocol provides encrypted communication and secure identification of a network web server. HTTPS connections are used in many situations in which sensitive information is being communicated. For instance, HTTPS is frequently used for payment transactions on the world wide web as well as other connections in which sensitive information may be communicated. The detailed operation of HTTPS and the involvement between the various communication network layers is not addressed in detail in this description as those of ordinary skill in the relevant art will be familiar with the technical aspects of HTTPS. As such, only a high-level overview of the technology is presented.

In the TCP/IP protocol stack, the SSL protocol sits between the TCP/IP layer protocol and the higher application-level protocols such as HTTP or SMTP. The SSL based implementation calls TCP/IP on behalf of the application, and it allows the SSL-enabled server and the SSL-enabled client to authenticate to each other and establish the encrypted connection between the two endpoints.

Use of SSL server authentication allows a user to confirm a server's identity. An application client that incorporates SSL-enabled software can use standard techniques of public-key cryptography to check that a server's certificate and public ID are valid and have been issued by a certificate authority listed in the client's list of trusted CAs. Such authentication is important from a user's perspective prior to transmitting valuable and sensitive information to the server over the network.

The use of SSL client authentication allows a server to confirm a user's identity. Using the same techniques as those for server authentication, a server that includes SSL-enabled software or web application can check that a client's certificate and public ID are valid and have been issued by a CA in the server's list of trusted CAs. Such confirmation is important if the server will be sending confidential information to the client and wants to verify the identity of the receiving client prior to the transmission of the information.

It should be appreciated that other techniques can be used to provide the secured transmission of data and client/server authentication and that the use of HTTPS is only one non-limiting example. For instance, closed networks, closed communication channels, static signing, manual encryption, VPNs, etc. could also be utilized

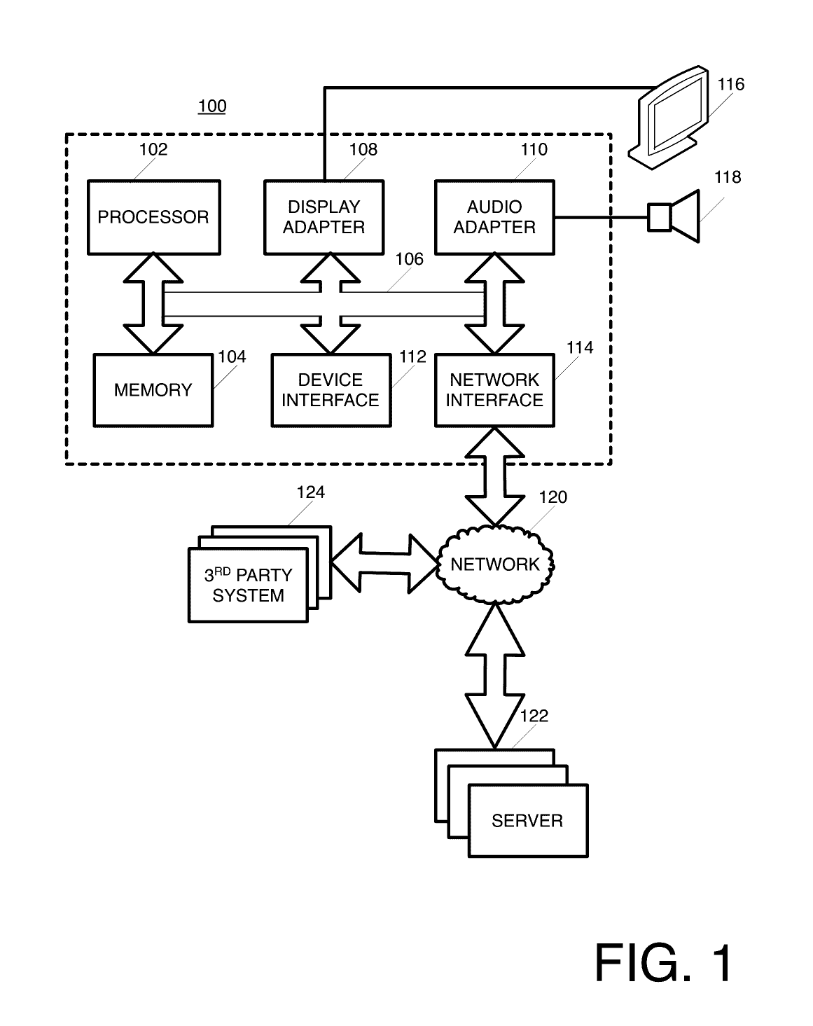

Turning now to the figures, FIG. 1 is a functional block diagram of the components of an exemplary environment or platform in which various embodiments of a computerized accounting information system and a method of processing accounting data may be implemented. It will be appreciated that not all of the components illustrated in FIG. 1 are required in all embodiments or implementations of the system or method, but each of the components are presented and described in conjunction with FIG. 1 to provide a complete and overall understanding. In addition, it will be appreciated that the embodiments of the system or method may be implemented in environments and/or platforms that may include other components and functionality. Therefore, the illustrated configuration is simply a non-limiting example.

The exemplary platform 100 is illustrated as including a processor 102 and a memory element 104. In some embodiments, the processor 102 and the memory element 104 may be communicatively coupled over a bus or similar interface 106. In other embodiments, the processor 102 and the memory element 104 may be fully or partially integrated with each other. The processor 102 may be any of a variety of processor types including microprocessors, micro-controllers, programmable arrays, custom ICs, etc., and may also include single or multiple processors with or without accelerators, or the like.

The memory element of 104 may include any of a variety of structures, including but not limited to RAM, ROM, magnetic media, optical media, bubble memory, FLASH memory, EPROM, EEPROM, etc. In addition, rather than being internal to the platform 100, the memory element 104 may be external to the platform 100 and accessed through a device interface 112 or a network interface 114.

The processor 102, or the other components of the platform 100, may also provide sub-components or functionalities such as a real-time clock, an analog-to-digital convertor, a digital-to-analog convertor, sensors, etc. The processor 102 may also interface to a variety of elements including a control/device interface 112, a display adapter 108, an audio adapter 110 and a network/device interface 114.

The control/device interface 112 may provide an interface to external devices, systems, equipment, sensor, actuators or the like. As non-limiting examples, the control/device interface 112 may be used to interface with devices or systems such as a keyboard, a mouse, a pin pad, an audio activate device, a gaming console, a gesture recognition sensor, an accelerometer, any other computer or processing device, as well as a variety of many other available input and output devices.

The display adapter 108 may be used to drive a variety of visually oriented elements 116, such as a display device including an LED display, LCD display, a Plasma display, a 3-D/holographic/virtual-reality display, one or more LEDs or other display devices, printers, etc. The audio adapter 110 may interface to and drive a variety of audible or other alert elements 118, such as a speaker, a speaker system, a buzzer, a bell, a vibrator, etc.

The network/device interface 114 may also be used to interface the platform 100 to any of a variety of other electronic devices or systems through a network 120. The network 120 may be a local network, a wide area network, a wireless network (WIFI, Bluetooth, cellular, 3G, LTE etc.), a global network such as the Internet, or any of a variety of other configurations including hybrids, etc. The network/device interface 114 may be a wired interface or a wireless interface.

The platform 100 is shown in FIG. 1 as interfacing to a server 122 and a third party system 124 through the network 120. Thus, the platform 100 may function independently, in connection with one or more systems, or even as a distributed system. It is envisioned that a battery or a power source provides power for the platform 100.

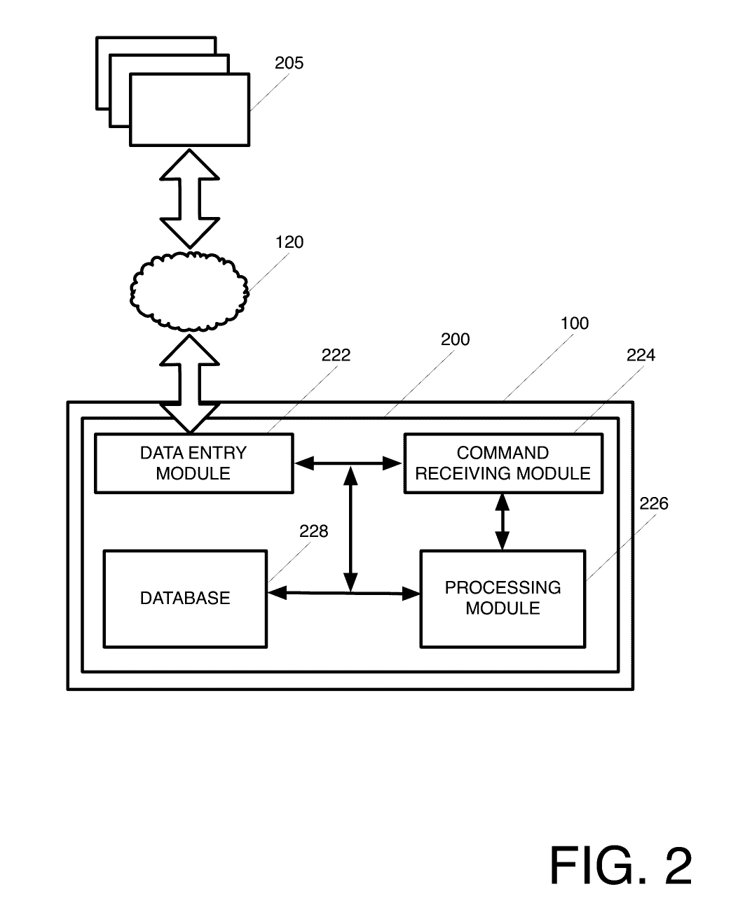

FIG. 2 is a functional block diagram of one exemplary embodiment of a computerized accounting information system. The computerized accounting information system 200 may be implemented on a platform such as the platform 100 of FIG. 1. Furthermore, the computerized accounting information system 200 may be accessible by one exemplary embodiment of an end-user platform 205. The computerized accounting information system 200 is comprised of a data entry module 222, a command receiving module 224, a processing module 226 and a database 228. However, the computerized accounting information system 200 may be comprised of various other modules or components providing any of a variety of functionalities not necessarily described in the following disclosure. Moreover, although the various functions are illustrated as being divided into various blocks, it will be appreciated that some of the functions may be implemented within common hardware, firmware and/or software components (such as those of FIGS. 1-2) and/or various functions may actually exist among two or more separate hardware, firmware and/or software components.

As should be understood by one having ordinary skill in the art, these components are communicatively coupled and may be dispersed throughout the architecture of the platform upon which the computerized accounting information system 200 is implemented. Furthermore, these components may be substantially discrete or may have considerable overlap, e.g., in terms of where, when and how they are stored, processed and operated. Therefore, FIG. 2's representation of these components as separate and distinct modules is merely for ease of description and visual representation and is not intended as a limitation or as the actual physical construction of the computerized accounting information system 200.

Moreover, in some exemplary embodiments, the end-user platform 205 is a data input device, or the like, that interfaces with the control/device interface 112 of the platform 100. Therefore, the end-user platform 205 may simply be an additional component of the platform upon which the computerized accounting information system 200 is implemented. On the other hand, the end-user platform 205 may exist as an entirely distinct environment or platform from the environment or platform upon which the computerized accounting information system 200 is implemented. Therefore, end-user platform 205 may be similarly configured as platform 100 of FIG. 1. As a result, it is envisioned that the end-user platform 205 may be communicatively coupled to a control/device interface, network interface, or any other similar component, through a network, or through any other applicable wired or wireless communications channel.

Moreover, in some exemplary embodiments, the data entry module 222 functions, at least in part, as an interface point between the end-user platform 205 and the computerized accounting information system 200. The data entry module 222 having the purpose of receiving, digitally storing and organizing the data entries from the end-user. Consequently, the data entry module 222 is configured to provide the end-user with the ability to label, categorize and/or organize data entries into fields (e.g., debits, credits, cash-flows in, cash-flows out, accounts receivable, liabilities, equity assets, capital assets, cash, debt, taxes). Furthermore, the data entry module 222 is additionally configured to aggregate data entries of different fields into over-arching transactions (e.g., the debits and credits involved with the sale of an asset as part of transaction 1 as distinct from the debits and credits involved with the acquisition of an asset as part of transaction 2). Furthermore, the data entry module 222 is additionally configured to provide the end-user with the ability to specify the accounting standard (e.g, U.S.A G.A.A.P., U.K. G.A.A.P, Plan Comptable Géneŕal of France, Grundsätze ordnungsmäβiger Buchführung of Germany, Chinese Accounting Standards of China and International Financial Reporting Standards) by which the data entries are characterized.

Because of the various physical locations wherein the data entry module 222 can be implemented, the data entry module 222 may take the form of a user-interface that is accessible remotely from the end-user platform 205 through a network, a wired connection, a wireless connection, etc. (e.g., stored in the cloud and accessed as online application or stored on a server and accessed through a webpage). Furthermore, the data entry module 222 may take the form of a packaged software bundle, or any downloadable piece of software known to one having ordinary skill in the art, that is implemented directly on the end-user platform 205 and which communicates with the other components of the computerized accounting information system 200.

Moreover, in some exemplary embodiments, the database 228 functions, at least in part, as the short-term or long-term storage for data entries received by the data entry module 222. The database 228 may be configured as a read-write medium capable of being accessed by the computerized accounting information system 200 or any other platform/system/software/module with need for the information stored therein. Therefore, the database 228 may be formatted to any standard known to one having ordinary skill in the art. Furthermore, the database 228 may be read and updated in real time by the data entry module 222 such that the user-interface can illustrate data entries, with their associated categorical/organizational/accounting standard metadata, that have been previously received by the computerized accounting information system 200. This function essentially allows the data entry module 222 to act as a browser for the information stored on the database 228.

Moreover, in some exemplary embodiments, the command receiving module 224 functions, at least in part, as an interface point for receiving a command to invoke an action within the computerized accounting information system 200. The received command may also identify the accounting standard pertinent to the desired action. The action invoked by the command may be any type of analytical accounting action, e.g., the production of reports, tax returns and other similar financial statements, that involves, at least in part, searching, compiling, discriminating, comparing and/or extrapolating meaning from the relevant data set. Consequently, the command receiving module 224 may be integrated, partially or fully, with data entry module 222 such that an end-user may specify the command directly within the user-interface. It is also envisioned that the command receiving module 224 may be stand-alone and capable of receiving the command, either pre-programmed or real-time selected, from other systems/platforms/environments.

Moreover, in some exemplary embodiments, the processing module 226 is configured to receive the data entries from the data entry module 222 and the command from the command receiving module 224 and perform the identified action. Because the command may also identify the account standard pertinent to the desired action, performance of the action by processing module 226 may be based, at least in part, on the identified accounting standard. As a result, the processing module 226 is configured to access the database 228 to leverage any other pertinent data entries previously received by the computerized accounting information system 200. The processing module 226 may also be configured to alert the end-user, at least in part, through the user-interface of the data entry module 222, if a data entry has not been received but that is needed for performance of the action. One having ordinary skill in the art should know that there are various methods and techniques for alerting an end-user that involve or do not involve the user-interface of the data entry module 222.

Because data entries may be labeled, categorized and/or organized into sub-fields and then aggregated into over-arching transactions, the processing module 226 may also be configured to recognize those sub-fields and to recognize those transactions most relevant to the identified action and the identified accounting standard in the command. Therefore, the processing module 226 may employ a smart logic to selectively search, filter and/or compile data entries for performing the identified action.

The processing module 226 may also be configured to analyze the data entries presently entered into the data entry module 222 (but not yet stored in the database 228) or the data entries previously received and stored in the database 228 (but not presently entered into the data entry module 222) for significant deviations from what would be expected as a consistent data entry under a particular accounting standard. Therefore, the processing module 226 may infer/extrapolate/compute this expected data entry based, at least in part, on a sample of related and relevant data entries under a similar transaction, or under a similar sub-field across a variety of transactions. The processing module 226 may provide an alert indicator if the data entries significantly deviate from the expected data entry. Additionally, the processing module 226 may be configured to prepopulate the data entry module 222 with a suggested place holder data entry (derived from the expected data entry) if the presently entered data entry significantly deviates from the expected data entry. This suggestion is intended to help guide the end-user to realize any possible mistakes in their data or in their characterization of the data using the intended accounting standard.

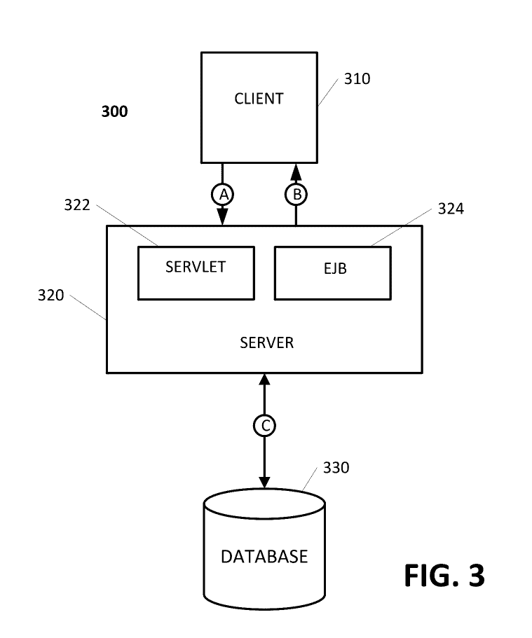

FIG. 3 is a functional block diagram of one exemplary embodiment of a functional environment in which a computerized accounting information system can be implemented. The exemplary computerized accounting information system 300 of FIG. 2 may be implemented within functional environment 300. Specifically, the environment 300 is an exemplary embodiment of a client-server application environment 300. The client-server application environment 300 is comprised of the components of an application client 310, a server 320 and a database 330. The description of FIG. 1 is applicable to the client 310 and server 320 and database 330 in certain exemplary embodiments.

Furthermore, the application client 310 is configured to communicate information to the server 320 over communication path A and receives communicated information from the server 320 over communication path B. A protocol such as HTTPS may be used to provide data privacy for information that is communicated between the application client 310 and the server 320 and enforces client authentication to limit access to the server 320 to authorized end-users. It will be appreciated by a person of ordinary skill in the relevant art that the computerized accounting information system 200 could be incorporated into any local or distributed computing environment and the illustrated example is just provided for purposes of explanation. Moreover, the communication protocol used between the application client 310 and the server 320 preferably enables a secured communication path but, it should be appreciated that in some embodiments, an unsecured communication path may also be utilized.

Furthermore, in describing the exemplary functional environment, the environment is presented as being based on Enterprise JAVA or J2EE technology. For the exemplary environment/platform of FIGS. 1-2, which emphasize a full-function accounting/book-keeping/ledger system (the computerized accounting information system 200, for example), a J2EE application that is broken down into three tiers is employed; the three entities being the application client 310 (client tier), the J2EE server 320 (web and business tier) and a database 330.

A person of ordinary skill in the art understands that the J2EE clients can be web clients or application clients. Web clients are generally described as being thin clients meaning that they do not query databases, execute complex business rules or connect with legacy applications. Application clients, on the other hand, are described as fat clients, run on a client machine and provide a richer user interface. Typically, such interfaces include a graphical user interface (GUI) created from the Swing or the Abstract Window Toolkit (AWT) API. When either configuration is utilized, these types of operations are generally performed by enterprise beans executing on the J2EE server. In typical J2EE based architectures, Javabeans are employed to manage the data flow between an application client and the components that are running on the J2EE server. Similarly, Javabeans are used to manage data flow between the J2EE server and the database.

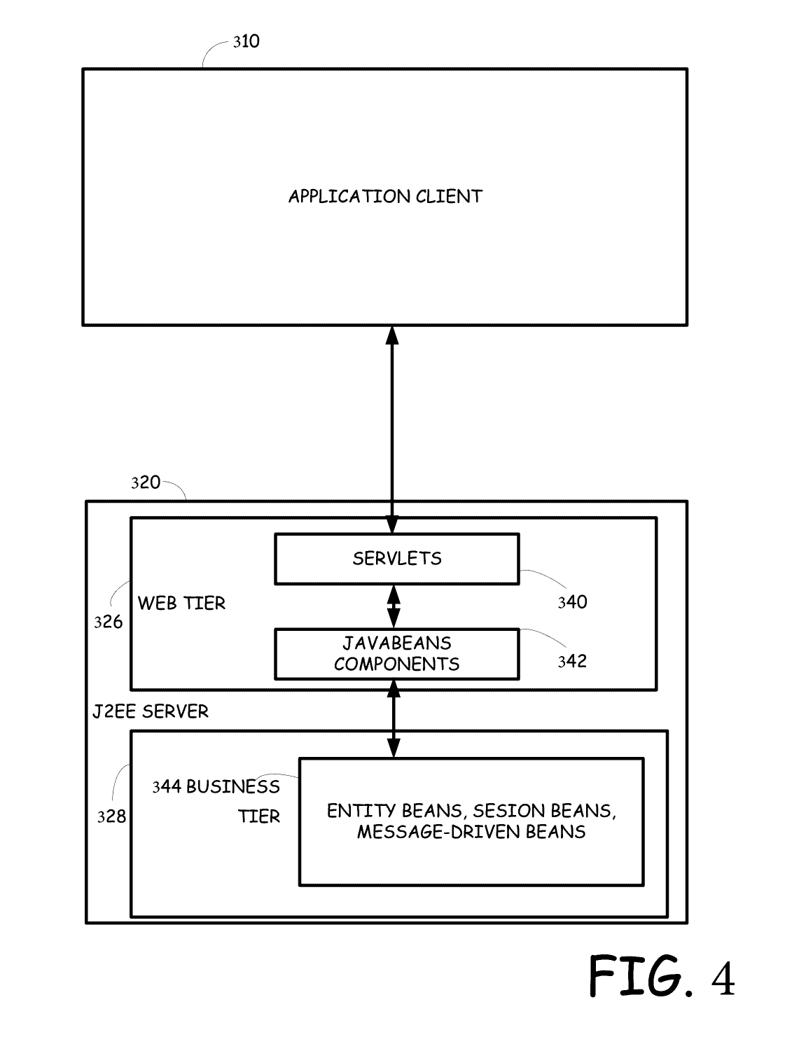

FIG. 4 is a block diagram of the components of an exemplary web server residing in a J2EE based architecture. The exemplary client-server application environment 300 of FIG. 3 may be implemented with the exemplary J2EE server 320 configuration. Specifically, the application client 310 runs on a client machine such as the end-user platform 205 of FIG. 2 and provides a way for users to handle tasks that require a richer user interface than can be provided by a markup language. It typically has a graphical user interface (GUI) created from the Swing or the Abstract Window Toolkit (AWT) API, but a command-line interface is certainly possible. The application client 310 directly accesses enterprise beans 344 running in the business tier 328 of the J2EE server 320. However, if application requirements warrant it, an application client 310 can open an HTTP connection to establish communication with a servlet 340 running in the web tier 326 of the J2EE server 320.

In a particular embodiment, the application client 310 is based on a java program, with a GUI rendered through Java Swing, that communicates with the J2EE server 320. The web tier consists only of servlets 340 and the business tier consists of the beans 344 (entity beans, sessions beans, message-driven beans, etc.).

The application client 310 communicates with the business tier 328 running on the server through the servlets 340 that are residing in the web tier 326 and JavaBeans components 342 that interface to the enterprise beans 344 residing in the business tier 328 on the server 320. Other details of the J2EE architecture and the deployment and development of entities within such an environment are known in the art and further detail is not presented herein.

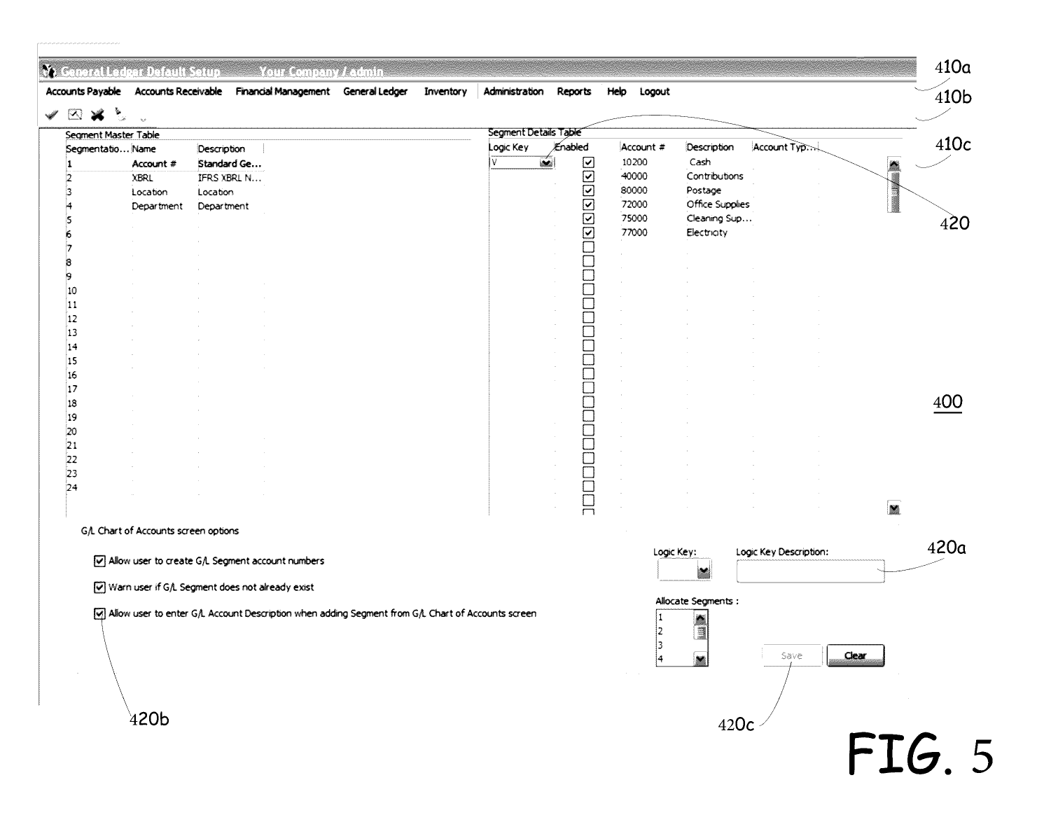

FIG. 5 is partial view of an exemplary screen structure selected from many available screen structures for a computerized accounting information system. The exemplary screen structure 400 may be processed and interfaced with at the application client 310 on a client machine such as the end-user platform 205 of FIG. 2. The screen view is based on SWING and Java Foundation classes, but other design technologies could be employed. The exemplary screen structure 400 consists of various elements constructed using a jframe and jpanel classes. The jframe is the physical window that is illustrated on the screen 400. The jpanel defines the various components that are included in the screen. The screen can include a variety of formats such as an online form, etc. The jpanels are containers for the components. The various frames 410a, 410b and 410c are presented on the screen 300 and then the components for each jframe are then added to the jpanel. Various component types can be presented, such as jbuttons, jlabels, radial buttons, text boxes, etc. In general, as a user actuates the various jpanel components, the state of the components can change, such as adding text in a box 420a, toggling a radial button or check box 420b etc. Once items are modified on the screen, the user can actuate the save panel 420c which causes the transmission of the data or actuations to be sent from the web client 310 to the server 320 and for updating the database 330. When the save panel 420c is actuated, this information is transferred over communication path A (FIG. 3) to the servlets 340 and invokes JavaBeans 344 in the business tier 328 of the server 320. The business tier 328 also includes one or more JavaBeans for controlling communication with the database 330. In general, the screen 300 is constructed such that there is a servlet per menu and a JavaBean per menu item as a non-limiting example.

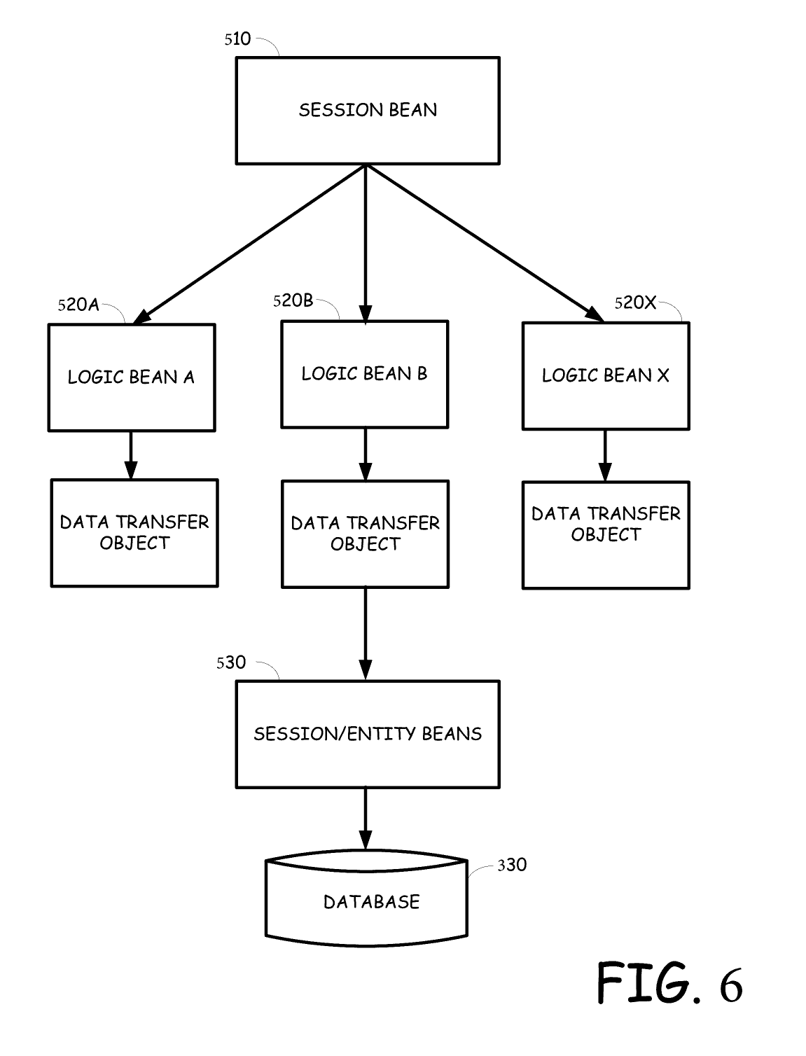

FIG. 6 is a conceptual diagram of one exemplary embodiment of an implementation of the server side logic of the exemplary web server residing in a J2EE based architecture. In particular, the server side logic of J2EE server 320 involves the servlet/session bean 510, which resides in the server 320, contains business logic and it operates in conjunction with various entity beans (LOGIC BEAN A 520A, LOGIC BEAN B 520B . . . LOGIC BEAN X 520X). The application client 310 initially loads the screen structures (such as the exemplary screen structure 400, for example) and retrieves any necessary data records from the database 330 through the server 320. Once loaded, the user can actuate various fields in the screen. When the user actuates the panels, actions local to the application client 310 may be invoked and/or actions that involve the use of the JavaBeans in the server 320 may be invoked. For instance, if the user modifies a text field, this is completely contained within the application client 310. However, if the user actuates the SAVE panel, the information is transferred to the servlet/session bean 510 which then talks to the various entity beans 520A, 520B-520X as necessary for updating the table and ultimately the server 320 uses one or more other JavaBeans 530 to update the database 330. It should be appreciated that although just one servlet/session bean 510 is illustrated, when the user actuates any action panel, such as the SAVE panel, the action may interact with any number of servlets depending on the tasks that need to be performed.

The database contains the storage for the various underlying data that is associated with the various fields, including fields that are stored along with the various tables and data (also known as logic keys). When the user activates these fields, activation data is stored along with the tables but, does not operate to modify the structure of the data in anyway other than to indicate activation. Activation records are acted upon by the client logic which operates to interpret the data in the tables based on the state of the activation records.

As such, when it is desired to create a customization, or to add new capabilities to the system, the logic key can be defined and the underlying business logic to implement the functions associated with activation record can be created. The functions can be performed either completely in the client logic, the JavaBeans or a combination of both. For an application client oriented implementation, as the data is received from the server 320, the application client 310 operates on and renders the data in accordance with the state of activation record for the added functionality and the business logic. Likewise, as the data is modified, the application client 310 performs actions in accordance with the state of activation record for the added functionality and the business logic, which may result in local actions and/or server based actions. For a server oriented implementation, the server may include logic to operate on the data based on the state of the activation record for the added functionality. Finally, for implementations that are application client and server based, the business logic may be shared between the application client 310 and the server 320. In either case, when defining and implementing a Logic Key, additional JavaBeans, including Session Beans and Logic Beans may be necessary in order to implement the added functionality.

Thus, it will be appreciated that a general client-server application system can be created for application to the general populous. The application can be utilized by a variety of clients for different entities. If a particular entity then desires the application client to be customized in a particular manner, the entity can request such customizations to be implemented through the use of activation of a logic key.

### Example 1

### Virtual Account

An entity or organization that has a single checking account but multiple operations can establish a virtual account to share the checking account and have all activity associated with financial transactions across the organization to be properly attributed and reconciled with the various operations.

Often, in accounting systems, the accounts, books and ledgers for a particular entity are separated into segments. The segments can be based on a variety of factors including the nature of the products or services, nature of production, type or class of customers for the products or services, the method used to distribute the products or provide the services, the geographic region for aspects of the business including economic and political conditions, special risks, exchange control regulations, underlying currency risks, etc. In general, a segment is a component of a business that can be utilized to track data related to the business, such as revenues and costs related to operations as a non-limiting example. The exemplary accounting system manages financial information for a segment's activities and performance.

In addition, within an accounting system, a particular element that is to be tracked may also be referred to as an account. For instance, a company may separate into segments individual business units as described above, or within a business or business unit, separate accounts based on aspects of the business. Table 1 illustrates a non-limiting example of accounts that can be set up in a general ledger for aspects of the business or business unit.

TABLE 1

| ACCOUNT NAME | ACCOUNT NUMBER |
|---|---|
| Cash | 10200 |
| Contributions | 40000 |
| Postage | 80000 |
| Office Supplies | 72000 |
| Cleaning Supplies | 75000 |
| Electricity | 77000 |

In operation, an organization will select the virtual account via the computerized accounting information system 200 to apply to an account. An exemplary implementation of a user interface for this feature is illustrated in FIG. 5 with reference to drop down menu item 420. As previously noted, the business logic associated with the virtual account would be developed for this particular logic key and as such, when the organization loads the accounting system, the underlying accounting data, as well as the business logic for the virtual account are loaded into the application client upon initialization.

In the presented example, the use of segments allows for the data to be dissected into any type of way that is desired. As a non-limiting example, the data can be dissected into geographic regions. Segment 002 may include all 50 states. To track operations in each state, the data can be pulled out for each state separately. As another non-limiting example, a segment can be used to dissect data as restricted, unrestricted or partially restricted. In accounting scenarios, typically a parent child relationship is created for segments. However, in the environment presented herein, the segments utilized to dissect the data can be completely independent or unrelated to each other. Within each segment, the accounting system includes at least one account. In a particular example, segment 1 is a general ledger. In implementation, the Logic Key applies to any account number within any segment. The Logic Key imparts intelligence with regards to a specific account number. The incorporation of the Logic Key conveys intelligence to any account within the accounting system.

The virtual account ensures automatic balancing among and across all segments and within each segment without requiring the operator to make accounting entries to keep the system in balance. To illustrate the operation of the virtual account, consider a charitable organization that has the funds as listed in Table-2

TABLE 2

| Fund Name | ID |
|---|---|
| Mission | MIS |
| Capital | CAP |
| Operating | OPR |
| Charity | CHA |
| Annex | ANX |
| Kitchen | KIT |
| Youth | YOU |
| Children | CHI |
| Benevolence | BEN |

Further, consider that the organization also includes the sub-funds presented in Table-3.

TABLE 3

| Sub-Fund Name | ID |
|---|---|
| Discipleship Training | 100 |
| VBS | 200 |
| Russia Trip | 300 |
| Repairs | 400 |
| Heart Ministries | 500 |
| Tom Hall Fund | 600 |
| Penfield Ministries | 700 |
| Awana's | 800 |

Each of these business activities and funds operate under a single organization that has a single checking account. In application of the virtual account, suppose the cash account is marked as a virtual account. As cash is received into or disbursed from the organizations, the transactions are recorded against the overall accounting system but, each of the activities/funds that draw from the account will also receive allocations of the cash transaction.

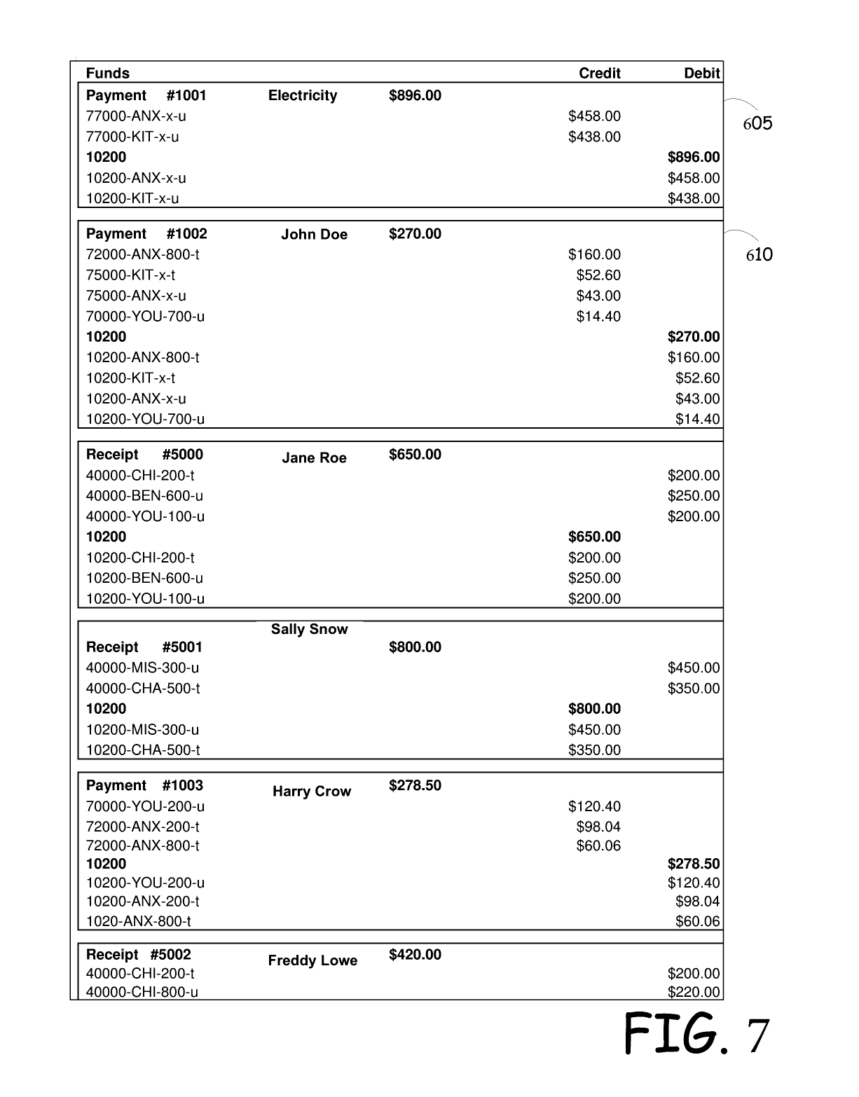

FIG. 7 is a table showing the allocation of funds received into the organization as cash transactions for Example 1. As can be seen, looking at the details for Payment #1001 for electricity 605, the electricity bill was $896.00. The cost for the electricity is debited against the cash segment 10200 but it is allocated across two funds, 10200-ANX for $458.00 and 10200-KIT for $438.00. Further, the appropriate segment for each fund also shows a credit for 77000-ANX and 77000-KIT. Similarly, Payment #1002 to John Doe 610 of $270 has been debited against the cash account 10200 and has been allocated across four funds 10200-ANX-800 (a sub fund), 10200-KIT, 10200-ANX and 10200-YOU-700 (a sub-fund). Likewise, the appropriate segment for each fund and sub-fund where applicable shows a credit respectively as 72000-ANX-800 (office supplies), 75000-KIT and 75000-ANX (cleaning supplies), and 70000-YOU (postage). Thus, when a check is received, in this particular example to be recorded as a cash receipt, the check can be broken down in the applicable activities/funds. The distribution is allocated in the Receipt Details screen as illustrated in FIG. 7.

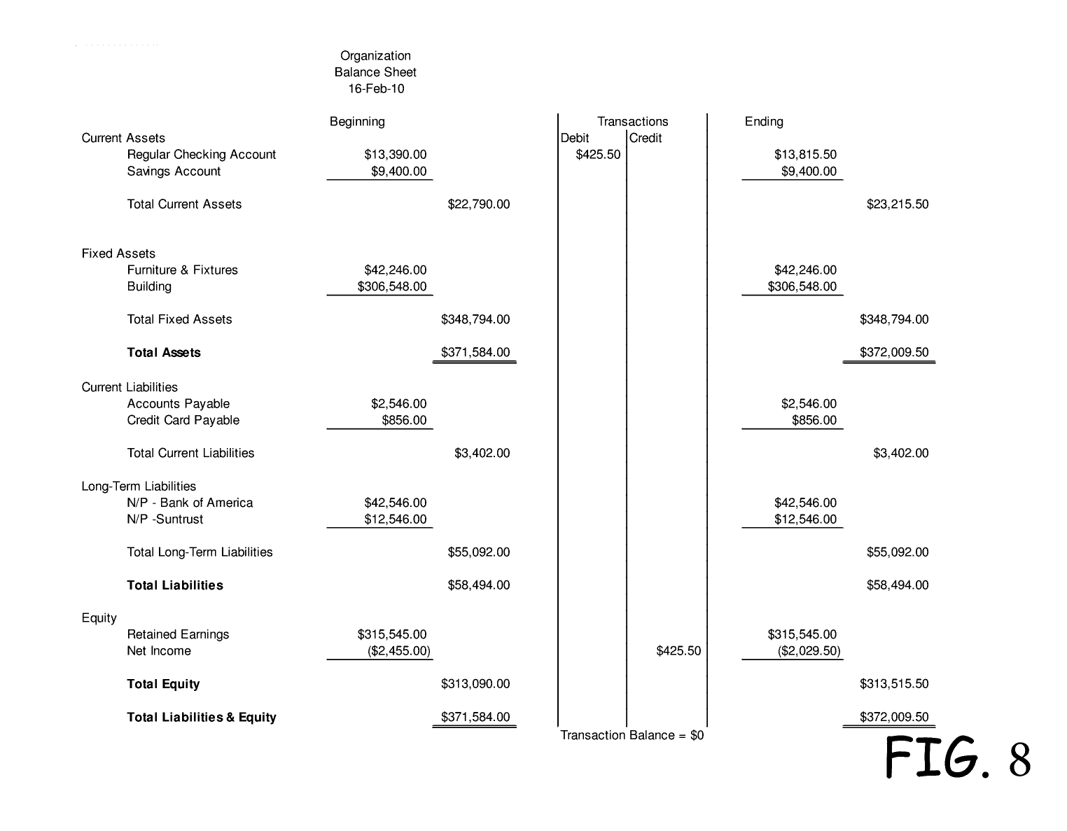

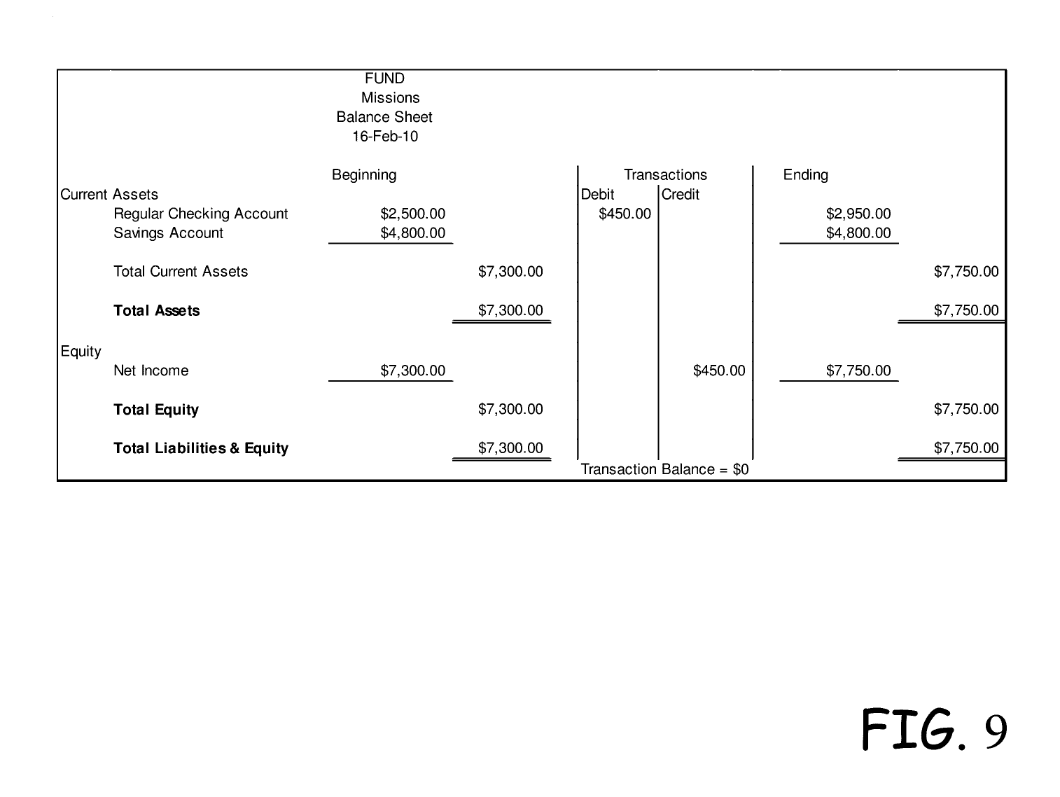

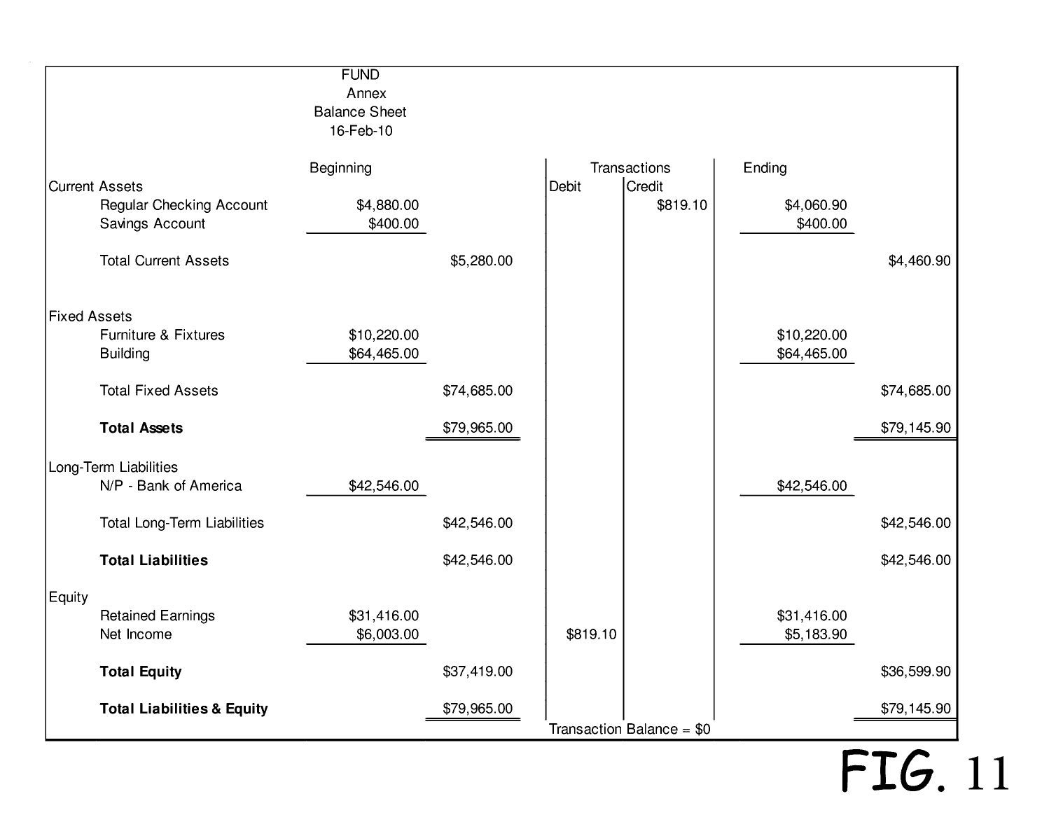

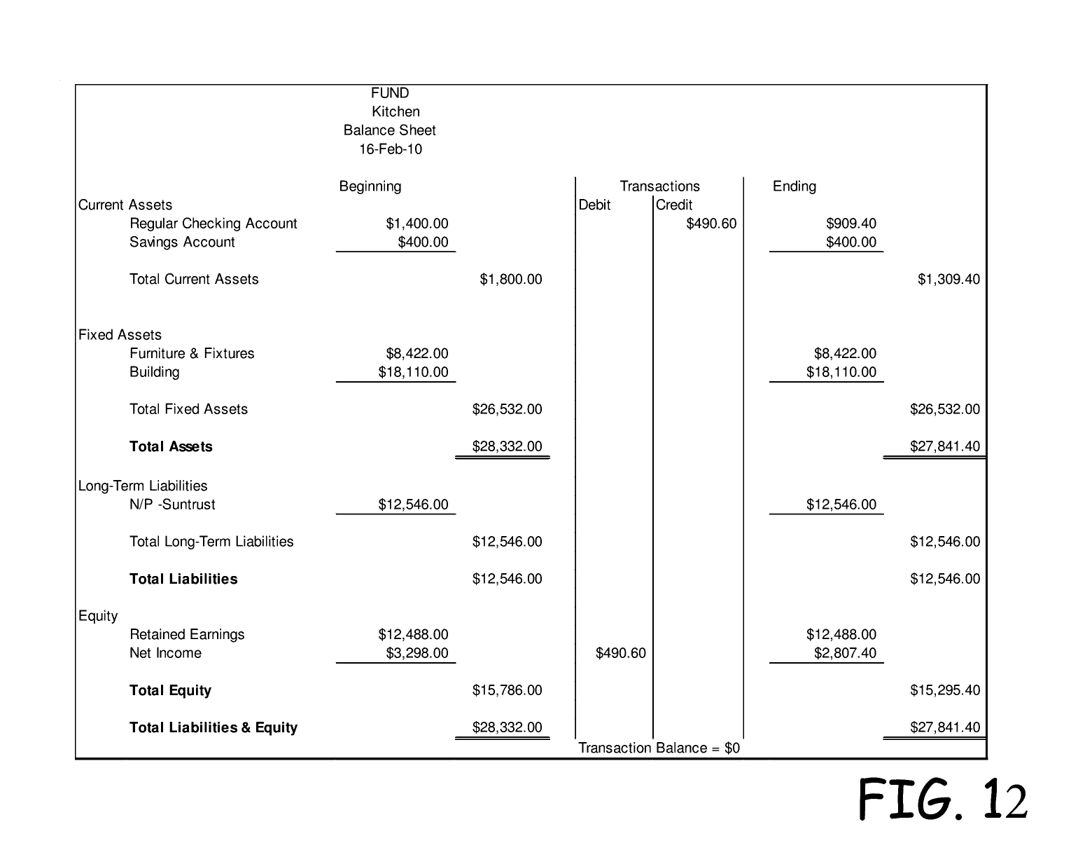

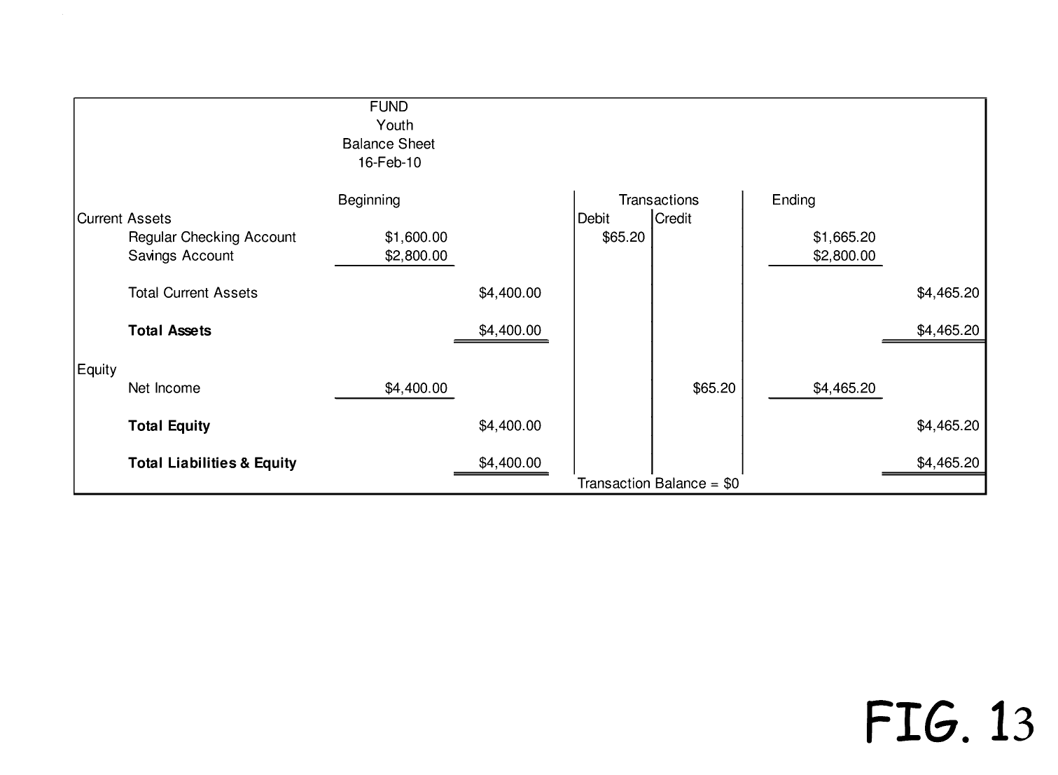

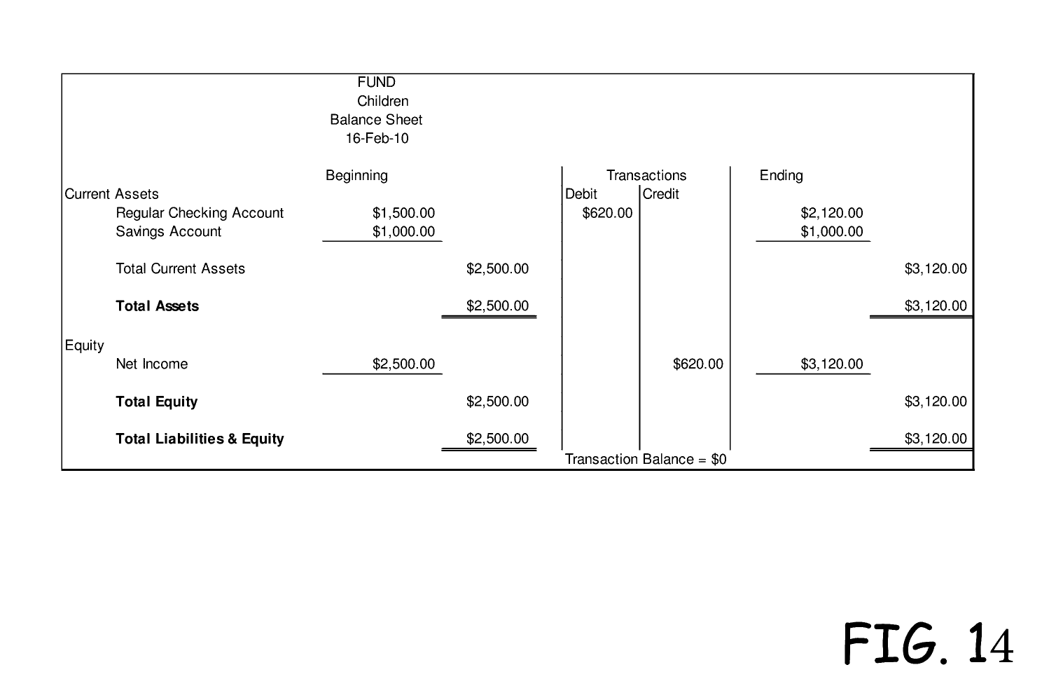

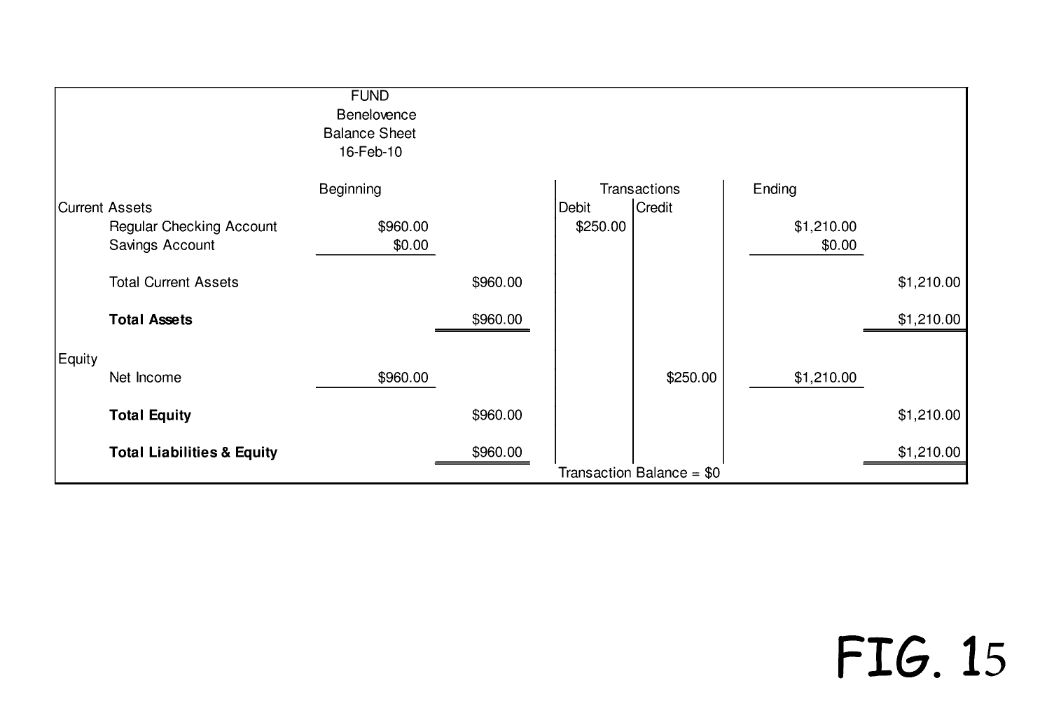

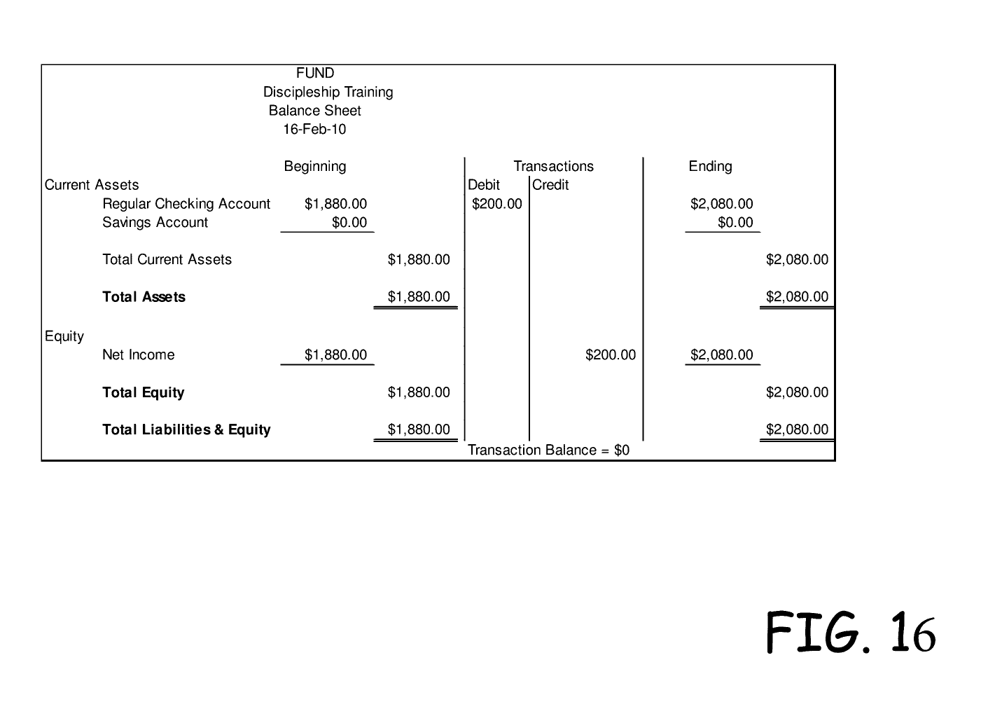

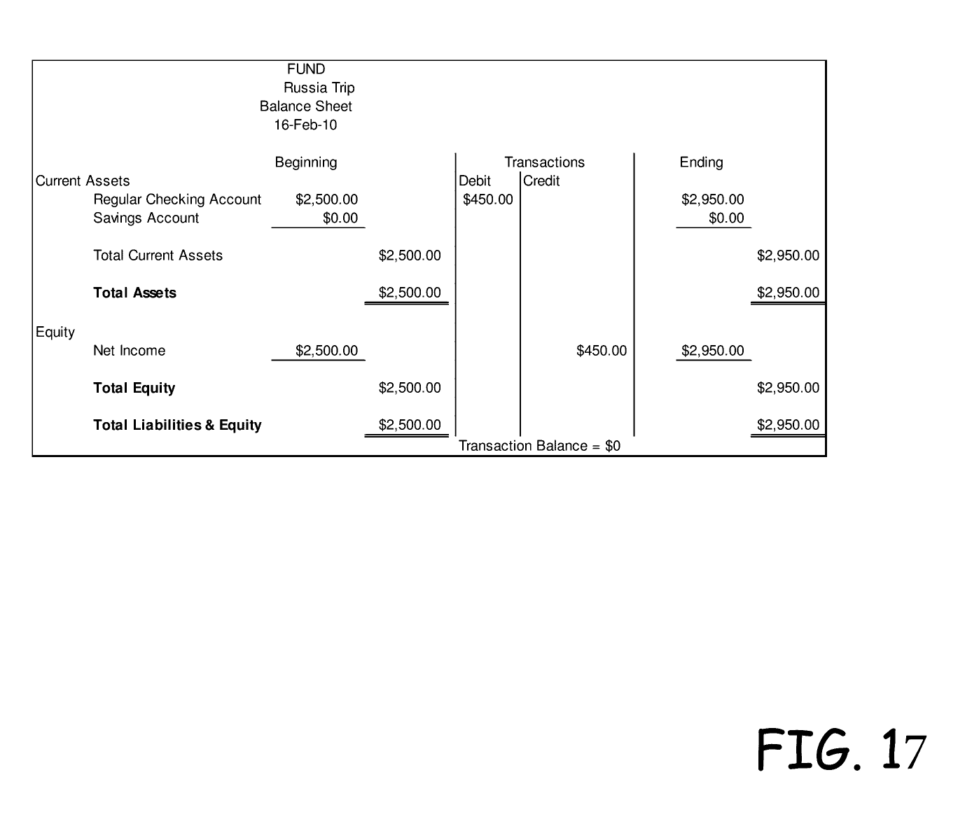

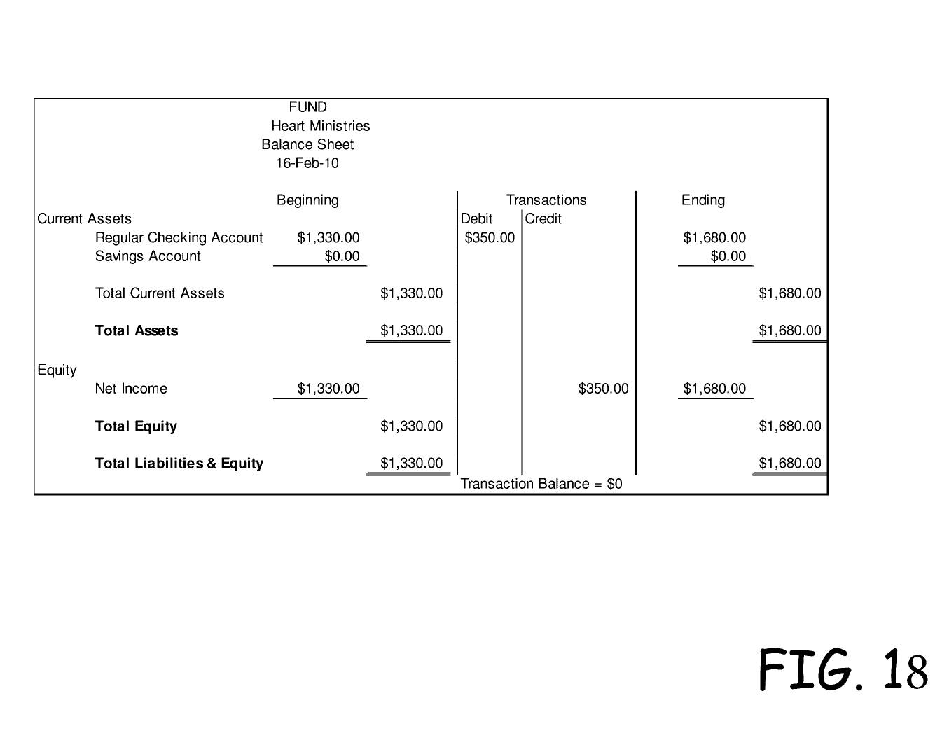

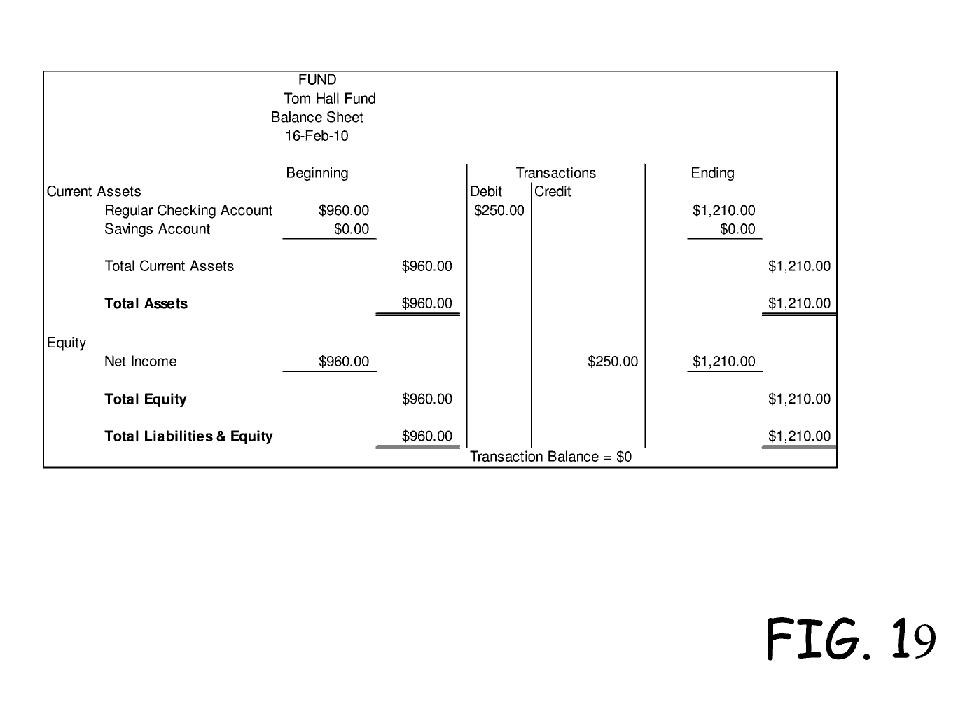

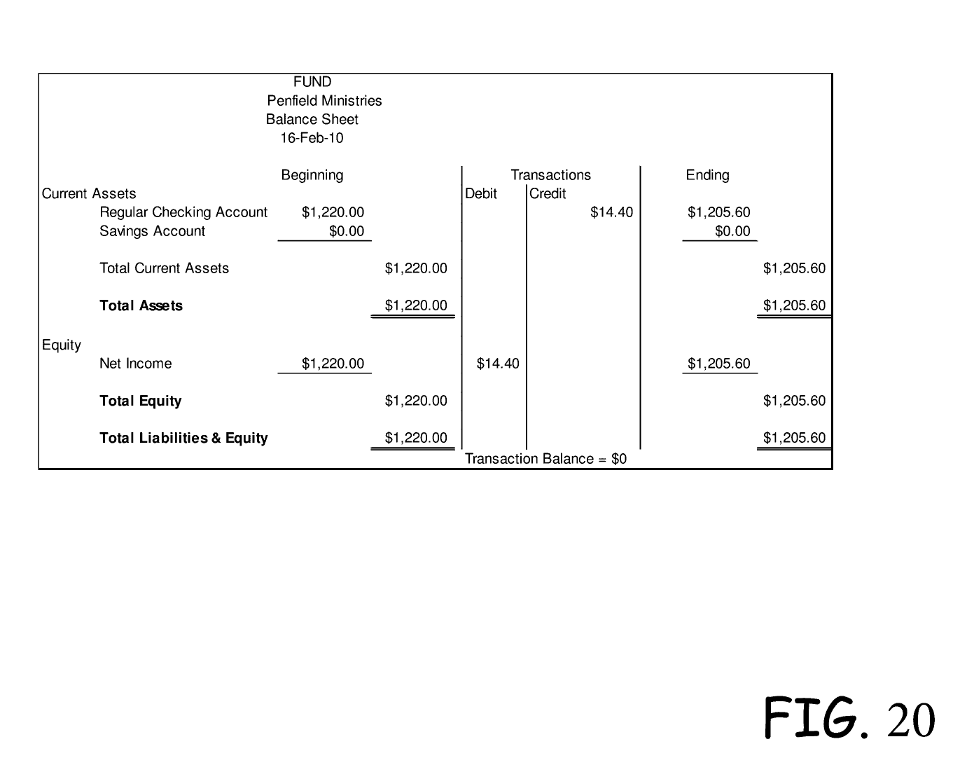

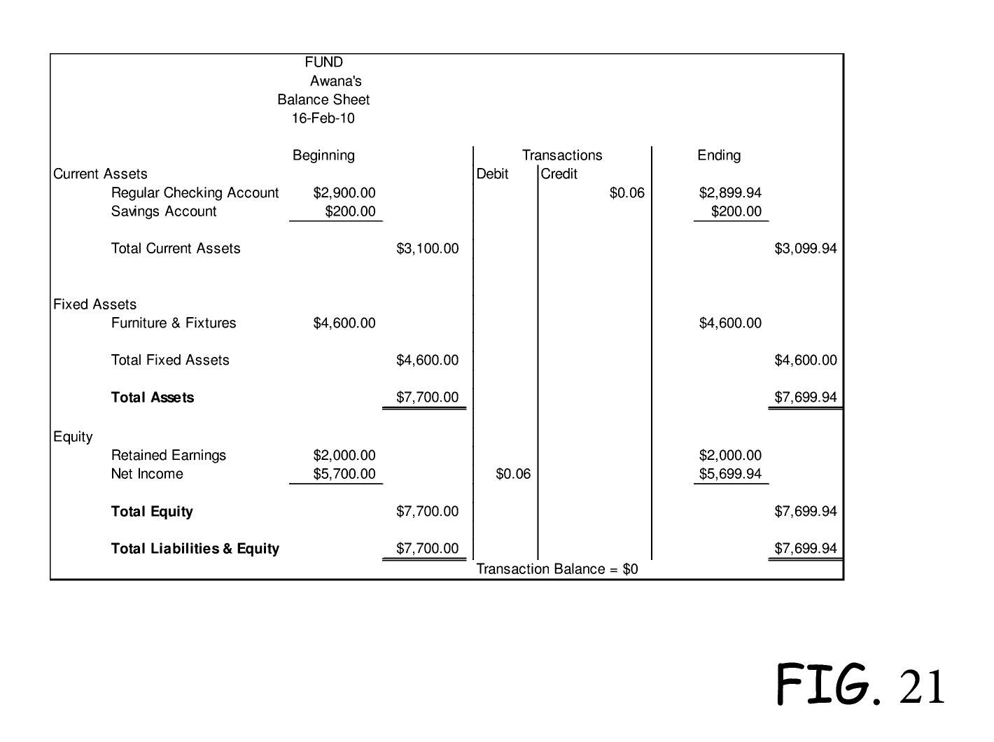

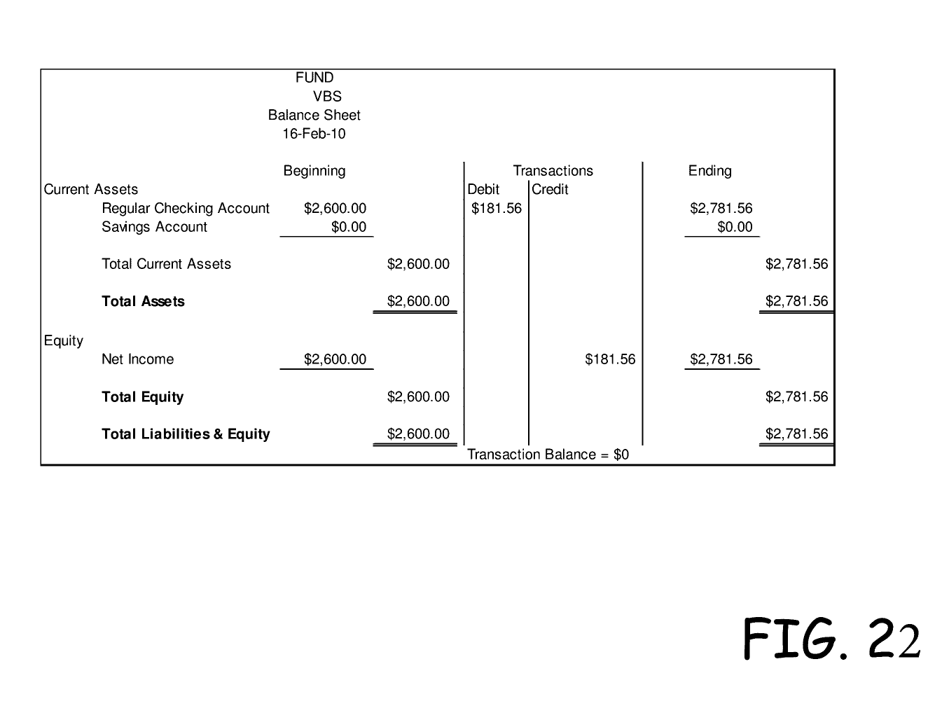

Advantageously, by earmarking the cash account 10200 as a virtual account (i.e., FIG. 5), the accounting system operates to maintain automatic balancing for the overall organization as well as each of the funds within the organization. The business logic developed in support of the virtual account added functionality, when activated (i.e. via a drop down menu as illustrated in FIG. 5 as a non-limiting example), maintains the information necessary to generate balance sheets for each of the funds. FIGS. 8-20 are exemplary balance sheets that can be automatically generated by the computerized accounting information system for an account that is marked with the virtual account added functionality of Example 1. A balance sheet can be generated for the overall organization as well as a balance sheet for each of the funds. In addition, balance sheets can also be generated for each sub-fund as well as other balance sheets based on other aspects of the funding, such as restricted, unrestricted, temporarily restricted, etc.

Thus, it should be appreciated from this example, that a highly complex accounting function is easily created within the confines of the computerized accounting information system system 200 by simply tagging an account with a virtual account activation field for the added functionality. Once an account is tagged as a virtual account, any checks posted to that account or payments made from that account will automatically be broken down into all activities and all funds associated with that account in accordance with the business logic. In addition, the integrity of the overall account is maintained and available for viewing. A user can view balance sheets, income statements, etc. for any activity or sub-activity as well as the complete operation of the entity and integrity and consistency is maintained across the operation. The business logic associated with the complexities is automatically loaded into the application client, as well as the report generations. As a web-based system, the functionality developed for the virtual account can be made available to other users of the accounting system or, if the functionality is proprietary, then it can be restricted and be available only to authorized users.

### Example 2

### Long Term Loans

As another non-limiting example of added functionality via the computerized accounting information system 200, consider requirements that may be imposed upon a borrower by a lender for approval of a long term loan. For instance, if an entity obtains a line of credit for $500K, for example, the lender may want to ensure that the risk associated with this loan is minimized. As such, the lender may require that the borrower meet certain guidelines or restrictions, such as ensuring a minimum amount of working capital and maintaining limits on accounts receivable. As a more specific example, suppose the lender required the borrower to maintain a working capital of $25K and that only 20% of the accounts receivable could be aged more than 60 days. Added functionality could be created to monitor and/or police the account and ensure that these restrictions are complied with by the user.

In operation, the restrictions would be provided to the accounting system organization overseeing and managing the computer accounting information system 200 to define the added functionality and generate the business logic to implement the restrictions. The business logic could be used to create margins to help ensure that the restrictions are not violated and to provide alarms when thresholds are being approached. For instance, if a certain percentage of the accounts receivable are out of compliance (aged more than 60 days in the present example), such as 10% as a non-limiting example, the business logic could generate a notice to the account manager to sound a warning that the accounts receivables should be policed as the 20% mark is being approached. The account manager can then take remedial measures. As another non-limiting example, reminder notices could be automatically sent to vendors or parties associated with accounts that are not in compliance. Further, the business logic may include a threshold trigger that would send a notice to the loan officer and/or financial institute underwriting the loan.

As such, it will be appreciated that such a function allows the general accounting operation to proceed as normal and the business logic works in the background, or independent from the normal accounting functions, to monitor for compliance and trigger notices when the account is moving towards non-compliance.

### Generation of Business Logic

As previously described, the entity maintaining the computerized accounting information system 200 is requested to develop the business logic for the requested added functionality and operates to do so based on a definition of the operating requirements. It should also be appreciated that some of the generation of the business logic could also be performed by a user of the system directly at the application client 310. For instance, in one embodiment, a set of added functionality may be provided to the user of the system as a library of functionality. The user then has the ability to pick and choose which added functionality to apply to the computerized accounting information system 200. In addition, one or more of the added functionalities within the library may also include open-ended definitions or parameters. For instance, looking again at the long-term loan compliance example (Example 2), the library may include a list of typical activities and conditions that could be monitored. Thus, if the user selects the accounts receivable compliance functionality, the user may be prompted to enter a percentage and an age restriction. Another condition may include ensuring that the outstanding account receivables are not centered on a single vendor, or a particular vendor that has been earmarked as a payment risk. Thus, the user can select the added functionality for this monitoring activity and provide additional information about vendors that have extraordinary high activity and good payment track records to be excluded from the list.

### Example 3

### Partnership Distributions

As yet another example of the use of the added functionality in the computerized accounting information system 200, consider the operation of a partnership in which debits and credits are to be allocated to the partnership members in accordance with a complex formula. The computerized accounting information system 200 can be utilized to keep track of the overall financial operations of the partnership. However, by tagging the accounts receivable with the activated added functionality for client based distributions, as checks are received, the funds can be allocated to the various members in accordance with business logic. For instance, suppose the partnership operates to place 10% of all receivables into a general bucket for partnership expenses, 15% to the member that originated the client, 10% to the member that manages the client, 5% to the member that reviews the billing for the client, and the remaining 45% to the member performing the work or to the general bucket if an employee performed the work. As a received payment is coded into the system, the business logic associated with the added functionality and the account receivables account automatically performs the complex formula so that the appropriate allocations are made. The overall credit is processed as in the overall general ledger but, each member in the partnership can be considered as a fund or activity. Thus, a general ledger is automatically kept for each member in the partnership to enable individual accounting at the member level as well as at the partnership level.

### MISCELLANEOUS EXAMPLES

It should be appreciated that the above-listed examples are non-limiting examples to illustrate the use of the added functionality in the computerized accounting information system 200. Other examples of using the added functionality are also anticipated. A few additional non-limiting examples are provided below. For instance, added functionality can be applied to ensure compliance with GAAP or IFRS regulations. The added functionality can be applied to any financial concept. The added functionality can be used to monitor internal financial ratios and provide an alert if they are out of range. Application of the added functionality to a geographic segment could be used to calculate the additional cost of raw materials that are not received from the geographic region due to shipping interruption. The added functionality could be used to implement a risk assessment function as well. The added functionality could be used to apply business logic to a geographical location segment and business activity segment to fixed assets placed in those areas to track fixed asset concentrations and location of those assets (construction waste containers tracking). Thus, as assets are moved from place to place, the system could monitor the locations of the assets and if a risk scenario is created, then to generate and alert to invoke remedial measures. As a particular example, the assets may include geo-tracking equipment that may automatically report the locations of the equipment to the tracking application. As the locations of the assets are received, the tracking application is updated to show the current location of the assets. Such an application could be selectively enhanced by the use of an added functionality that would invoke a risk assessment functionality. The risk assessment functionality could be based on various algorithms that would define an increased risk. As non-limiting examples, the algorithm could identify a risk as a large number of assets being located in small region, expensive assets being located in an area that is known to be subject to vandalism, equipment being conjugated in a flood plain during a rainy season or upon determining that a hurricane is approaching the area, etc.

In a purchasing system, the concept of the added functionality could be used to implement specific functionality for a user as well. For instance, the business logic for monitoring exchange rates, production requirements, etc., could be implemented for a particular product, production plant, etc. When the account is tagged as being associated with the Logic Key, then notices to the purchasing agent can indicate when exchange rates should invoke order changes. Further, if the system is equipped to automatically order supplies as production ensues, the system could allocate orders based on current exchange rates.

As yet another example, the user could have an added functionality that works only if the general ledger account number plus the account name/number in another segment is used. For example, account number 15,250 in segment #1 is a container asset plus account name Egypt in segment #3, then usage of any general ledger account that includes 15250-x-Egypt-x-x . . . will invoke the logic key to perform a predetermined process, such as risk monitoring. Also, the added functionality examples immediately above can be further refined by referencing the date of purchase or a range of dates for all assets in account #1 (container assets). This demonstrates that the added functionality may be highly refined and is not limited to information contained within accounts of any particular segment only. This displays the capacity of achieving a high level of intelligence in the business system which may be implemented with precision.

Thus, it will be appreciated that the Logic Key operates to add functionality into a web-based application and/or a client-server application without having to modify the underlying operations of the web-based application, the client-server application and/or the application client. Aspects or embodiments of the added functionality can be incorporated into a variety of settings ranging from thin clients to fat clients, Internet-based applications or other network based applications, and even stand-alone applications that can be configured to specific user functionality. By providing business logic for one or more added functionality, the user can access customized functionality, or specialized functionality for the computerized accounting information system 200. The system provider can still service other users with the standard capabilities and provide enhanced or modified capabilities to particular users. Further, in an accounting system, for example, a complete accounting package can be provided for general accounting functionality but, specific needs for particular business or business sectors can be addressed by adding functionality and capabilities.

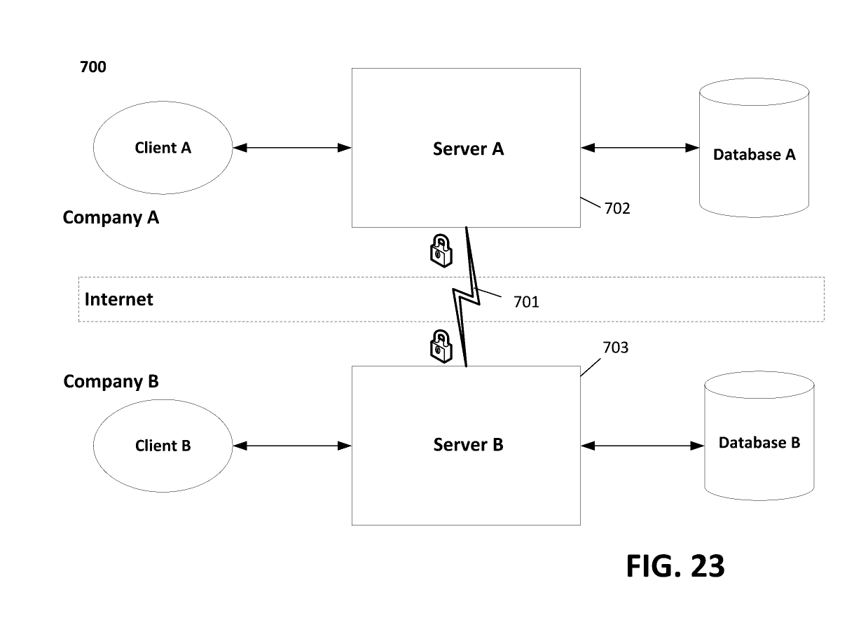

FIG. 23 is a block diagram of the exemplary use of a secure communication path between participating entities implementing the computerized accounting information system. The exemplary computer accounting information system 200 of FIG. 2 may involve the secure communication path described. Specifically, a protocol such as HTTPS can be utilized as a non-limiting example of a secure communication path. HTTPS, which is an acronym for Hypertext Transfer Protocol over SSL, is a protocol utilizing TCP to transfer hypertext requests and information between servers and other servers, and between servers and browsers. The use of this protocol provides encrypted communication and secure identification of a network web server. HTTPS connections are used in many situations in which sensitive information is being communicated. For instance, HTTPS is frequently used for payment transactions on the World Wide Web, as well as other connections in which sensitive information may be communicated. The detailed operation of HTTPS and the involvement between the various communication network layers is not addressed in detail in this description, as those of ordinary skill in the relevant art will be familiar with the technical aspects of HTTPS. As such, only a high-level overview of the technology is presented. HTTPS provides data privacy for information that is communicated between entities utilizing the application being described. For purposes of this description, FIG. 23 illustrates a secure communication path 701 between the Server A 702 of participating entity Company A and the Server B 703 of participating entity Company B.

Use of SSL server authentication allows a user to confirm a server's identity. An application that incorporates SSL-enabled software can use standard techniques of public-key cryptography to check that a server's certificate and public ID are valid and have been issued by a trusted certificate authority. Such confirmation is important—if the servers will be transmitting confidential information over the connection, the identity of the receiver should be validated prior to the transmission of the information.

It should be appreciated that the communication path between the server and client of a given entity (i.e., Server A and Client A) may be secured using HTTPS or other techniques, and that may or may not involve accessing the internet.

It should be appreciated that other techniques can be used to provide the secured transmission of data and client/server communication and authentication, and that the use of HTTPS is only one non-limiting example. For instance, closed networks, closed communication channels, static signing, manual encryption, VPNs, etc. could also be utilized.

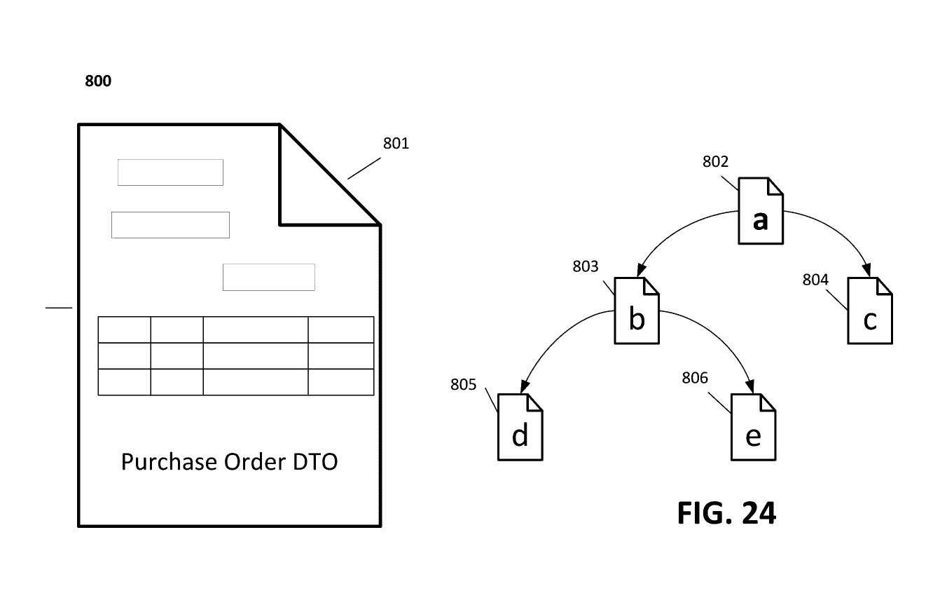

FIG. 24 is a conceptual diagram of the components of an exemplary data transfer object for a client-server object oriented architecture. The exemplary data transfer object 800 is configured to operate on the client-server application environment 300 of FIG. 3 implemented with the exemplary J2EE server 320 configuration. Object-oriented programs are based on the concept of objects that interact with each other, unlike more conventional programming methods that view a program as essentially a list of tasks to be performed. The details of object-oriented programming and the interaction between data objects and other processing functions or routines is not explained here, as those of ordinary skill in the relevant art will be familiar with the technical aspects of object-oriented programming. For the purposes of this application, an object is a self-contained piece of programming code that combines data and the processing instructions needed to manipulate it. If an object also includes the code and processing instructions needed to carry data from one location (or processing step) to another, it can be referred to as a data transfer object (DTO). As a non-limiting example, DTO 801 contains the data relating to a purchase order, the processing instructions needed to manipulate said data, and the processing instructions needed to carry said data from one location (or processing step) to another.

Objects can refer to other objects. As another non-limiting example, DTO 802 (a) references objects 803 (b) and 804 (c). In turn, object 803 (b) refers to objects 805 (d) and 806 (e). It should be appreciated that objects can reference other objects, regardless of whether or not any of the objects involved are DTOs. Any or all of the objects 802, 803, 804, 805, and 806 can be a data transfer object (DTO). In an exemplary embodiment of the secure data exchange technique, data relating to a given business transaction is encapsulated into a DTO that can be transmitted from the business management system of one participating entity to those of other participating entities.

It should be appreciated that a DTO is not a remote user connection between participating entities, nor does a DTO require a remote user connection to be transmitted between participating entities.

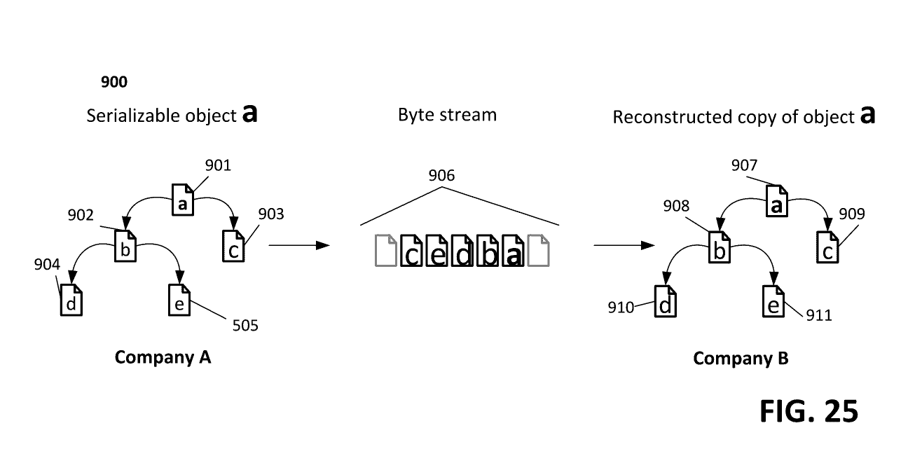

FIG. 25 is a conceptual diagram illustrating the concept of object serialization for a client-server object oriented architecture. More particularly, FIG. 25 depicts the concepts of serializable data transfer objects, the byte streams of serializable data transfer objects, and reconstruction of serializable transfer objects. In an exemplary embodiment of the secure data exchange technique, the DTO of a given business transaction is made serializable so it functions as a comprehensive “diary” of that transaction. A serializable DTO is converted into a byte stream that preserves the DTO exactly—the stream includes all the DTO's data and all references to other objects needed to reconstruct the DTO at another time, or even another place. As a non-limiting example, serializable DTO 901 references objects 902 and 903. Object 902, in turn, references objects 904 and 905. DTO (a) 901, containing all its references is converted into byte stream 906. This allows DTO (a) 901 to be reconstructed, complete with all its references, at another time or location. DTO (a) 907 represents a reconstructed copy of DTO (a) 901. Object (b) 908 corresponds with object 902 (b), object (c) 909 with object (c) 903, object (d) 910 with object (d) 804, and object (e) 911 with object (e) 905.

The descriptions of exemplary embodiments of the secure data exchange technique utilize the non-limiting example of a business transaction conducted between two participating entities—Company A and Company B. Company A orders widgets from Company B, which establishes their common accounting link. Both companies use the same business management system and have agreed to use the secure data exchange technique to exchange data with each other relevant to their business transactions. As such, each has established a secure communication path utilizing HTTPS and a public/private encryption key system, which provides encrypted communication and secure identification of a network web server.

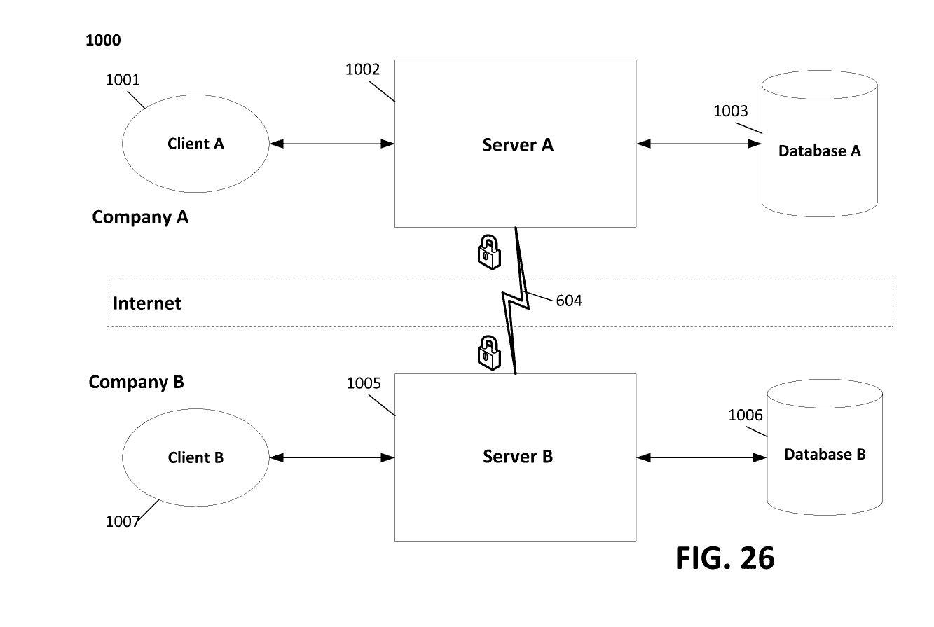

FIG. 26 is a block diagram of an exemplary embodiment of a business management system/computerized accounting information system of participating entities Company A and Company B, and the secure communication path between the two entities. In the illustrated embodiment, the business management system 1000/computerized accounting information system 200 may be a web-based or web-centric accounting and general ledger system in a client-server configuration like that described in FIGS. 2-4.

A user in Company A initiates a business transaction by creating a record—for example, a Purchase Order for ten steel widgets—in a client module associated with Client A 1001 and transmits it to Server A 1002, which saves the record in Database A 1003. Server A 1002 then encapsulates the data contained in the record into a serializable DTO, encrypts it, then transfers it over secure path 1004 to Company B's Server B 1005, where it is decrypted and saved in Database B 1006.

Entities utilizing this illustrated embodiment can easily create new records based on the data contained in a DTO. Via Client B 607, a user in Company B sees that Company A has sent a DTO, and creates a Sales Order in Client B 607 with data from Company A's DTO. The system populates the data from the DTO into the appropriate fields of the Sales Order. The user enters any additional information needed regarding the order and transmits it from Client B 1007 to Server B 1005, which saves the record to Database B 1006 and modifies the DTO to include the data from the Sales Order. In this way, all the records associated with a transaction are linked by the DTO. Server B 1005 encrypts and transfers the DTO over secure path 1004 to Server A 1002, which decrypts it and stores it in Database A 1003.

It should be appreciated that the above description explains the basic steps for creating and modifying a DTO using an exemplary embodiment of the secure data exchange technique being described. Any addition, deletion, or modification of data linked to a DTO modifies the DTO, and the newly modified DTO is automatically transmitted to the participating entities.

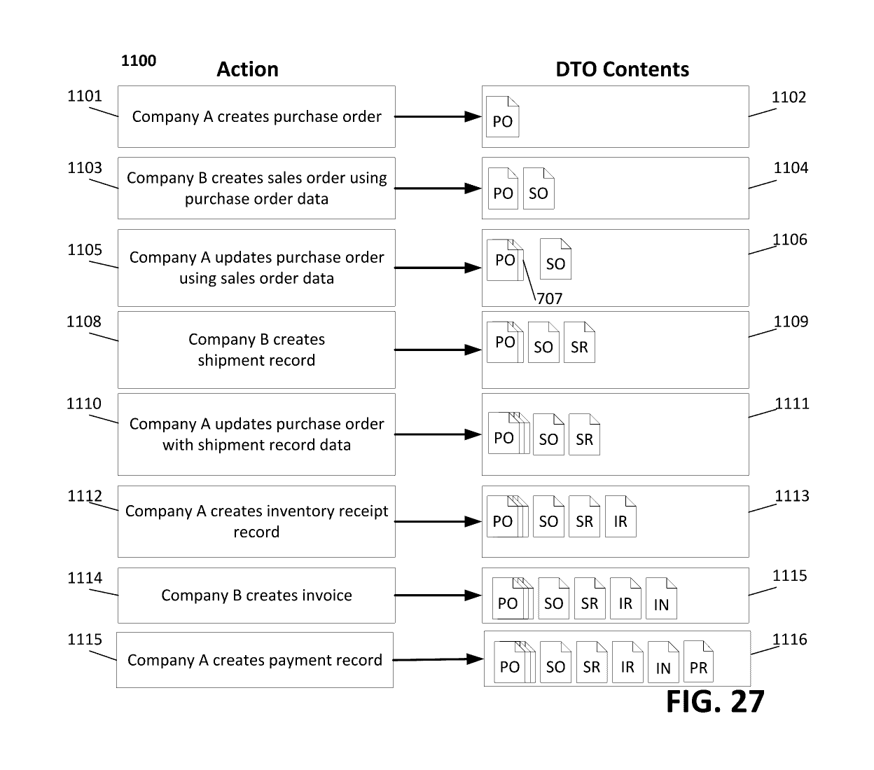

FIG. 27 is a flow diagram of the contents of an exemplary DTO as participating entities access and modify it during an exemplary business transaction handled via a business management system/computerized accounting information system. At the onset, as described above, a business transaction has been initiated by creating a purchase order. At action 1101, a DTO is created based on the purchase order created by Company A as reflected in DTO Contents block 1102. As described above, a new record is then created. At action 1103, Company B, upon receiving the purchase order from Company A, creates a sales order using the purchase order data. The DTO contents are modified as reflected in DTO Contents block 1104 to create the sales order. As the example scenario progresses, the contents of the DTO are illustrated in FIG. 27.

Because all the records associated with a transaction are linked by the DTO, users can easily update records linked by the object with data from other records linked by the object. For example, when the Company A user sees the modified object from Company B, the user chooses to update the Purchase Order record with data from Company B's Sales Order at action 1105. As a result, the DTO contents of the purchase order are modified as reflected in DTO Contents block 1106. In this step, an existing object is modified—the object representing the Purchase Order. Instead of creating a new object representing the modification, the Purchase Order object is simply referenced as in 1107, since a DTO byte stream can contain only one copy of an object.

Users from one entity can modify the DTO in ways that do not necessarily require action by the other entity or entities. In our non-limiting example, if the Company B user sees that Company A has updated its Purchase Order, there is no need to do anything in response; however, Company B may opt to modify the Sales Order accordingly.

When the Company B user ships the items identified in Company A's Purchase Order, the user creates a new record—a Shipment Entry—in Company B's system at action 1108. Action 1108 then modifies the DTO as reflected in DTO Contents block 1109 where the Shipment Record now appears. The Company A user may update the Purchase Order with data from the Shipment Entry. Thus, at action 1110, the Company A user modifies the DTO by referencing the Purchase Order again as reflected in DTO Contents block 1111.

Because all the records associated with a transaction are linked by the DTO, users can easily verify the status of the entire transaction. When the Company A user receives the shipment of items in the Purchase Order, the user documents it by creating an Inventory Receipt record. Thus, in action 1112 the user modifies the DTO as reflected in DTO Contents block 1113.

When the user at Company B sees that the shipment has been received, the user creates an Invoice for Company A at action 1114. In this process, the user from Company B modifies the DTO as reflected in DTO Contents block 1115 where the invoice now appears. The Company A user pays the invoice at action 1116 and creates an AP Payment record as reflected in DTO Contents block 1117.

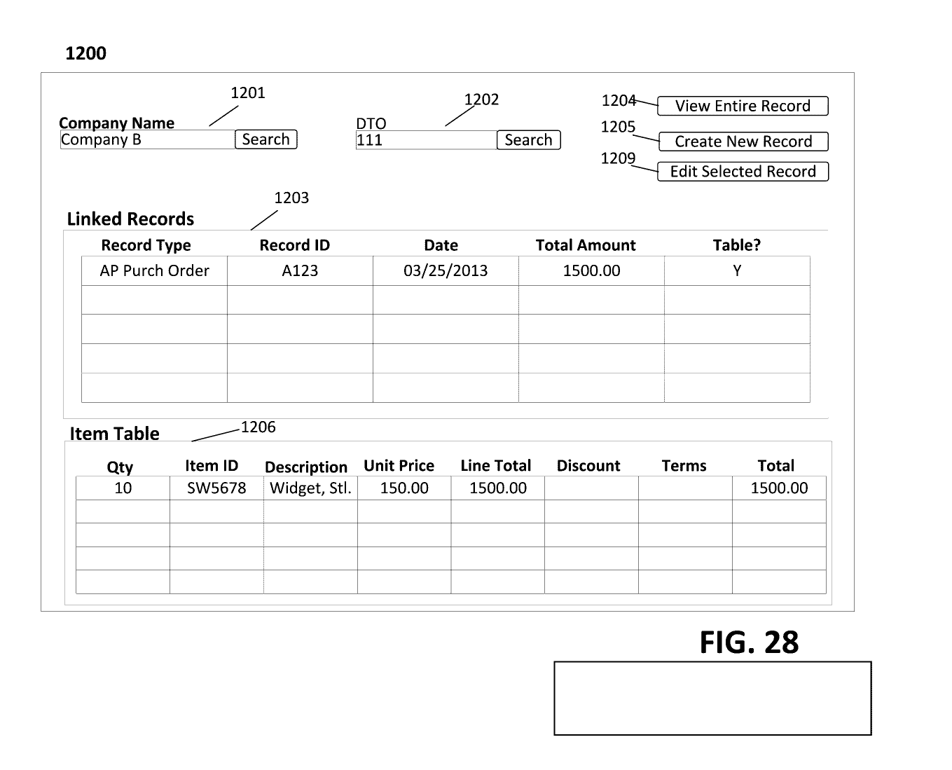

FIG. 28 is a partial view of an exemplary screen structure of a conceptual user interface selected from many available screen structures in a computerized accounting information system. The screen structure is for accessing, creating, and modifying DTOs relating to the secure data exchange technique. A person of ordinary skill in the art appreciates that this is a non-limiting example of a conceptual user interface, and as such, all elements depicted in this figure are non-limiting examples as well. The exemplary screen includes controls, tables, rows, columns, fields, labels, links, and a variety of other elements; the configuration, placement, grouping, size, arrangement, or combination of elements; and all other concepts or elements depicted in this figure are non-limiting.

The user selects the desired company via Company Name search dialog 1201, and the desired DTO via DTO search dialog 1202. Alternatively, the user can utilize DTO search dialog 1202 without using a Company Name search dialog 1201, since each DTO will typically have a unique identifier.

Once the DTO is selected, a list of the records comprising it is displayed in Linked Records table 1203. Each row contains information for one record. A record can be selected by clicking on its corresponding row in the table. If the selected record includes an item table, the contents of the item table display in Item Table 1206. The entire contents of the selected record are displayed by clicking View Entire Record button 1204. The selected record can be accessed and edited by clicking Edit Selected Record button 1209. In an exemplary embodiment, a participating entity can only edit records it originated; it cannot edit records it did not originate; however, in some embodiments it will be appreciated that certain editing functions may be included. A new record can be created by clicking Create New Record button 1205. Records created in this manner are linked to the DTO being viewed.

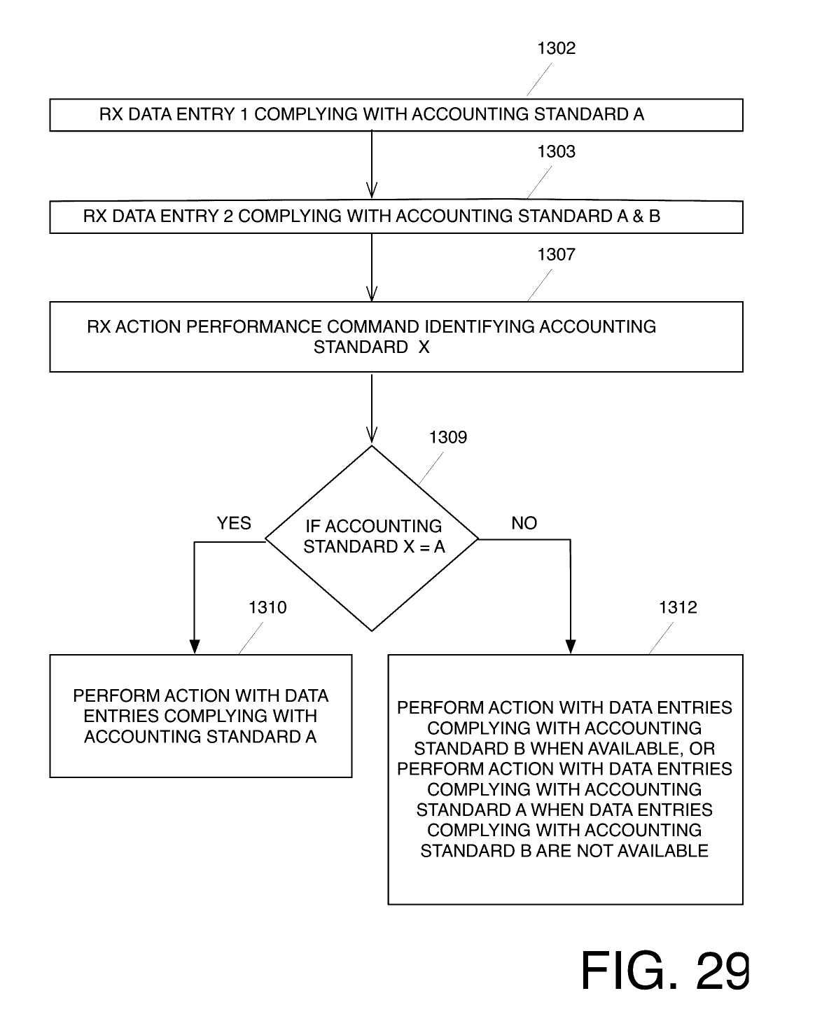

FIG. 29 is a flowchart diagram illustrating actions that may be implemented by some embodiments of the computerized accounting information system, or that may be included within a method of processing accounting data. While these actions may be presented in particular order, a person having ordinary skill in the art understands that this order is merely for ease of description and, therefore, is not intended as a limitation.

Initially, data for a first type of data field (e.g., debit, credit, cash-flow in, cash-flow out, account receivable, liability, equity asset, capital asset, cash, debt, tax) is entered into the computerized accounting information system. This can be done in a variety of manners such as reading data from a file, receiving a download of data, receiving individual data inputs, or any other manners known by one having ordinary skill in the art. Overall, a data entry for a first type of data field is received wherein the data complies with at least a default accounting standard, “A” (1302). A data entry for a second type of data field is also received wherein the data complies with the default accounting standard “A” and at least one other accounting standard “B” (1303). Multiple other data entries may also be received, and these other data entries may each comply with a variety of permutations of accounting standards for a particular type of data field. In one class of embodiments, all the data entries at least comply with the default accounting standard. However, other classes of embodiments may not impose this restriction.

Any received data entry may be stored in the database 228/330 for later access or they may be received and used without storage. Therefore, regardless of whether the data entries will be stored or received-used-discarded, Table 1a is intended to depict, as a non-limiting embodiment, how received data entries may be compiled and organized for use directly from the end-user or pulled from a database. For purposes of Table 1a, the “Data Entry ID” identifier, e.g., 1, 2, 3, is intended to differentiate between different data entries. The triplet letter designation, e.g., XXX, YYY, is intended to differentiate between the different types of data fields. The “Accounting Standard” identifier, e.g., [none], ′, ″, on the triplet letter designation is intended to differentiate between the different accounting standards by which the data entries may comply.

TABLE 4

| Data | Accounting Standard | | |
|---|---|---|---|
| Entry ID | A | B | C |
| 1 | XXX | | |
| 2 | YYY | Y′Y′Y′ | |
| 3 | ZZZ | Z′Z′Z′ | |

Therefore, Table-4 depicts that “Data Entry ID” 1 for a first type of data field (e.g., cash-flow out) was received, and that this data entry complied with the “A” accounting standard. Table 1a also depicts that “Data Entry ID” 2 for a second type of data field was received (e.g., cash-flow in) and this data entry complied with the “A” accounting standard and at least one other accounting standard; specifically, the “B” accounting standard. Table-4 also depicts that “Data Entry ID” 3 for a third type of data field was received (e.g., account receivable) and this data entry complied with the “A” accounting standard and at least one other accounting standard; specifically, the “B” accounting standard.

After the data has been entered into the system, a command to perform an action is received. The command may also identify one or more accounting standards for performance of the action or, in the absence thereof, the default accounting standard may be assumed. Other information or instructions for performance of the action, or the like, may also be included with the command (1307).

Thus, the command is basically a request to perform an action. The action is to be influenced or based, at least in part, on the identified accounting standard or standards. If the identified accounting standard is the “A” accounting standard (1309), then the action of the command is performed with one or more data entries that comply with the “A” accounting standard (1310). However, if the identified accounting standard is the “B” accounting standard (1309), then the action of the command is performed with one or more data entries that comply with the “B” accounting standard, if available (1312). If not available, then the action of the command is performed with one or more data entries that comply with the “A” accounting standard for each of the one or more data entries that is unavailable in the “B” accounting standard (1312).

It should be appreciated that Table-4 illustrates a simplified structure and that, in practice, the structure may be more complex in nature. For example, a data entry for a type of data field may be more complex than merely an entry into one “field” as seemingly illustrated by the triplet letter designation in Table-4. Instead, the data entry may be into one or more fields represented by the triplet letter designation; the one or more fields based, at least in part, on the applicable accounting standard characterizing that specific data entry. For instance, consider a situation in which a law firm receives a single check from a specific client for a specific legal service provided (i.e. one specific cash-flow in). This specific check constitutes one specific data entry, for example, “Data Entry ID” 2 of Table-4. If the applicable accounting standard characterizing “Data Entry ID” 2 is the “A” accounting standard, a portion of the check total amount may be allocated to a variety of fields represented by the triplet letter designation YYY: one third to “over head cost recoupment,” one third to “origination fee allocation” and one third to “firm income.” However, if the applicable accounting standard characterizing “Data Entry ID” 2 is the “B” accounting standard, the entire check total amount may be allocated to one field represented by the triplet letter designation YYY: “firm income.” Similarly, if the applicable accounting standard characterizing “Data Entry ID” 2 is the “C” accounting standard, the entire check total amount may be allocated to a variety of fields represented by the triplet letter designation YYY: one fourth to “business development cost recoupment,” one fourth to “origination fee allocation,” one fourth to “management cost recoupment” and one fourth to “firm income.”

Table-5 depicts, as an exemplary embodiment, how received data entries such as those of the law firm example may be compiled and organized for use directly from the end-user or pulled from a database. For purposes of Table-5, the “Field ID” identifier, e.g., 1, 2, 3, is intended to differentiate between different fields in which data may be entered for the specific “Data Entry ID” 2 depending on the applicable accounting standard. Specifically, “Field ID” 1 is “over head cost recoupment,” “Field ID” 2 is “origination fee allocation,” “Field ID” 3 is “firm income,” “Field ID” 4 is “business development cost recoupment” and “Field ID” 5 is “management cost recoupment.”

TABLE 5

| | Data Entry ID 2 | | |
|---|---|---|---|
| FIELD ID | YYY | Y′Y′Y′ | Y″Y″Y″ |
| 1 | 1/3 | — | — |
| 2 | 1/3 | — | 1/4 |
| 3 | 1/3 | 1/1 | 1/4 |
| 4 | — | — | 1/4 |
| 5 | — | — | 1/4 |

Therefore, Table-5 depicts the various ways in which the total value of the client check to the law firm, “Data Entry ID” 2, may have been entered/distributed into the computerized accounting information system. If “Data Entry ID” 2 complied with the “A” accounting standard, then a data entry for Field ID″ 1, “Field ID” 2 and “Field ID” 3 was received. If “Data Entry ID” 2 complied with the “B” accounting standard, then a data entry for Field ID″ 3 was received. If “Data Entry ID” 2 complied with the “C” accounting standard, then a data entry for Field ID″ 2, “Field ID” 3, “Field ID” 4 and “Field ID” 5 was received.

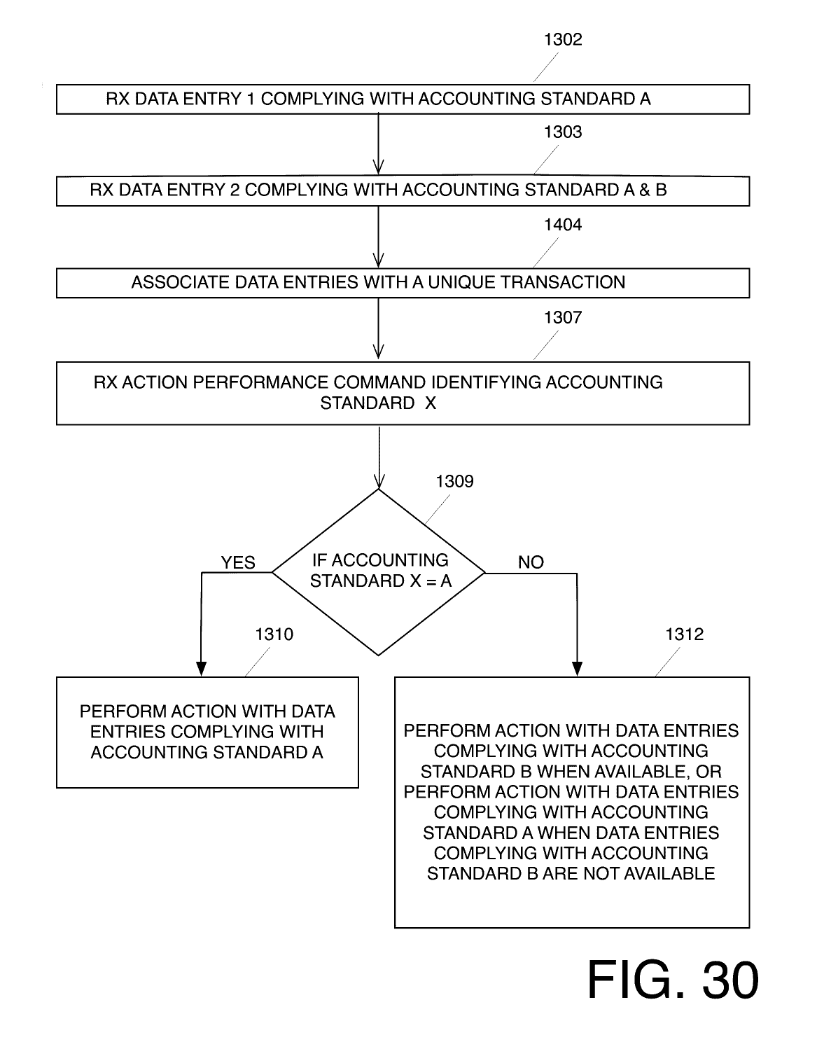

FIG. 30 is a flowchart diagram illustrating actions that may be implemented by some embodiments of the computerized accounting information system, or that may be included within a method of processing accounting data. Specifically, FIG. 30 is the flowchart diagram of FIG. 29 with an additional action.

As is described above, the data entries may be labeled, categorized and/or organized into individual fields of data (e.g., debit, credit, cash-flow in, cash-flow out, account receivable, liability, equity asset, capital asset, cash, debt, tax). The data entries of different individual types of fields of data may also be aggregated into over-arching transactions (e.g., the debits and credits involved with the sale of an asset as part of one specific transaction as distinct from the debits and credits involved with the acquisition of an asset as part of an entirely distinct transaction). Therefore, multiple data entries for the same type of data field may be received by the computerized accounting information system for various different unique transactions.

For instance, consider the previously described situation wherein the law firm received a single check from a specific client for a specific legal service provided (i.e. one specific cash-flow in). It is possible that this one specific cash-flow in (one type of data field) may be part of a larger over-arching transaction that involves certain cash-flows out, certain accounts receivable owed by the client to the law firm, etc. While the specific check may constitute one specific data entry, for example “Data Entry ID” 2 of Table-4, the account receivable owed by the client to the law firm may constitute another specific data entry, for example “Data Entry ID” 3 of Table-4. It is possible that these two data entries may be received together as one aggregate unique transactional data entry representing the larger financial transactions between the law firm and the client. It also possible that an entirely different client has a similar accounting transactions with the law firm that similarly involves that same types of data fields, e.g., a cash-flow into the firm, in terms of a received payment check, and an account receivable owed by this client to the firm. Like the first client, it is possible that the larger over-arching financial transaction may be received as one aggregate unique transactional data entry representing the larger financial transaction between the law firm and this second client.

As a result, in FIG. 30, a data entry for a unique transaction into the computerized accounting information system may not merely encompass data for one type of data field, e.g., only XXX or only YYY or only ZZZ; instead, a data entry may encompass data for multiple types of data fields, e.g., XXX and YYY and/or ZZZ. Therefore, in order to distinguish between sub-categories of data in the received data entries, e.g., “Data Entry ID” 1, “Data Entry ID” 2, the data entries were associated with the unique transaction (1404).

Table-6 depicts, as an exemplary embodiment, how received data entries for unique transactions may be compiled and organized for use. For purposes of Table-6, the triplet letter designation, e.g., ααα, βββ, is intended to differentiate between different unique transactions. As a result, Table-6's triplet greek letter designation may encompass one or more sub-categories of data for any type of data field, e.g., XXX, YYY, ZZZ. Like Table-4, the “Accounting Standard” identifier, e.g., [none], ′, ″, on the triplet letter designation is intended to differentiate between the different accounting standards by which the data entries, and any of their sub-categories of data, may comply.

TABLE 6

| Data | Accounting Standard | | |
|---|---|---|---|
| Entry ID | A | B | C |
| 1 | ααα | | |
| 2 | βββ | β′β′β′ | |

Therefore, Table-6 depicts that “Data Entry ID” 1 for the ααα unique transaction (e.g, the transaction related to the first law firm client) was received and that this data entry, and all of its sub-categories of data, complied with the “A” accounting standard. Table-6 also depicts that the “Data Entry ID” 2 for the βββ (e.g., the transaction related to the second law firm client) was received and that this data entry, and all of its sub-categories of data, complied with the “A” accounting standard and the “B” accounting standard. One having ordinary skill in the art should understand that the description of Table-6 is equally applicable to data entries for unique transactions and/or any of their sub-categories of data.

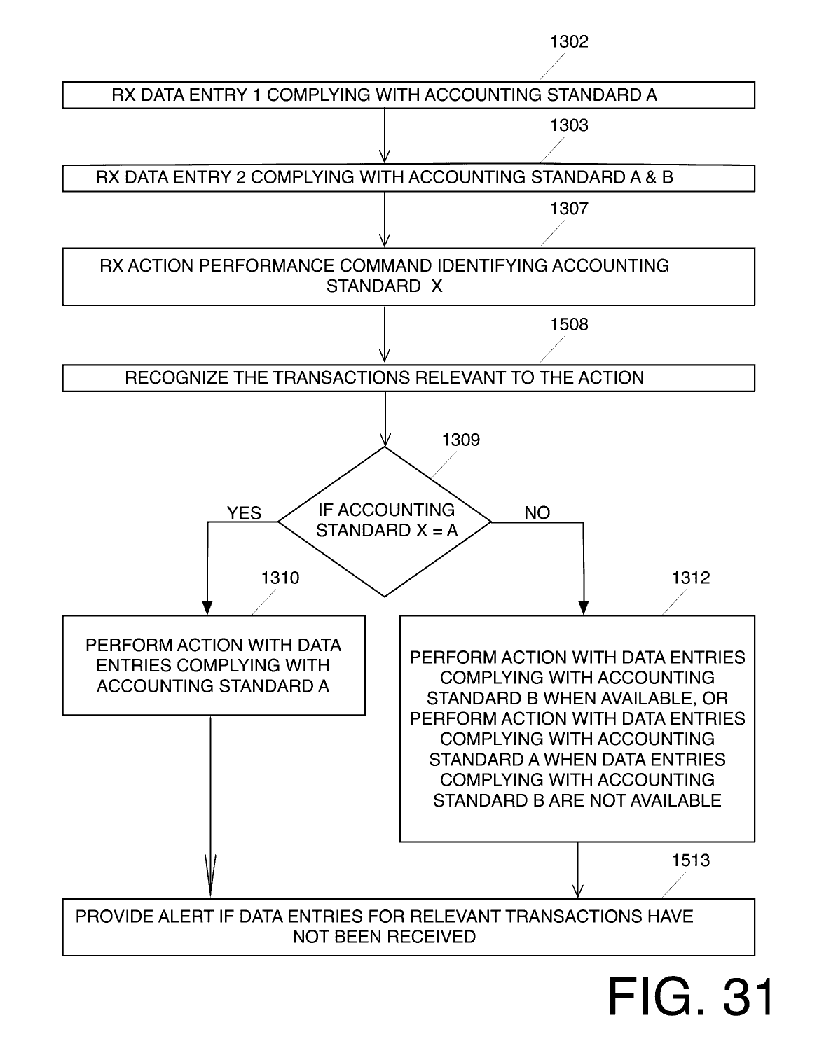

FIG. 31 is a flowchart diagram illustrating actions that may be implemented in some embodiments of the computerized accounting information system, or that may be included within a method of processing accounting data. Specifically, FIG. 31 is the flowchart diagram of FIG. 29 with additional actions.

As is described above, because data entries may be labeled, categorized and/or organized into sub-fields and then aggregated into over-arching transactions, it is envisioned that it is possible to leverage a smart logic to selectively search, filter and/or compile those sub-fields and to recognize those transactions most relevant to the identified action and accounting standard in the received command. Therefore, as is illustrated in FIG. 31, each data field type is a unique transaction and the unique transactions relevant to performing the action are recognized (1508). If a data entry has not been received for one or more relevant transactions, an alert indicator is provided that, as a non-limiting embodiment, notifies the end-user that additional data may be required (1513).

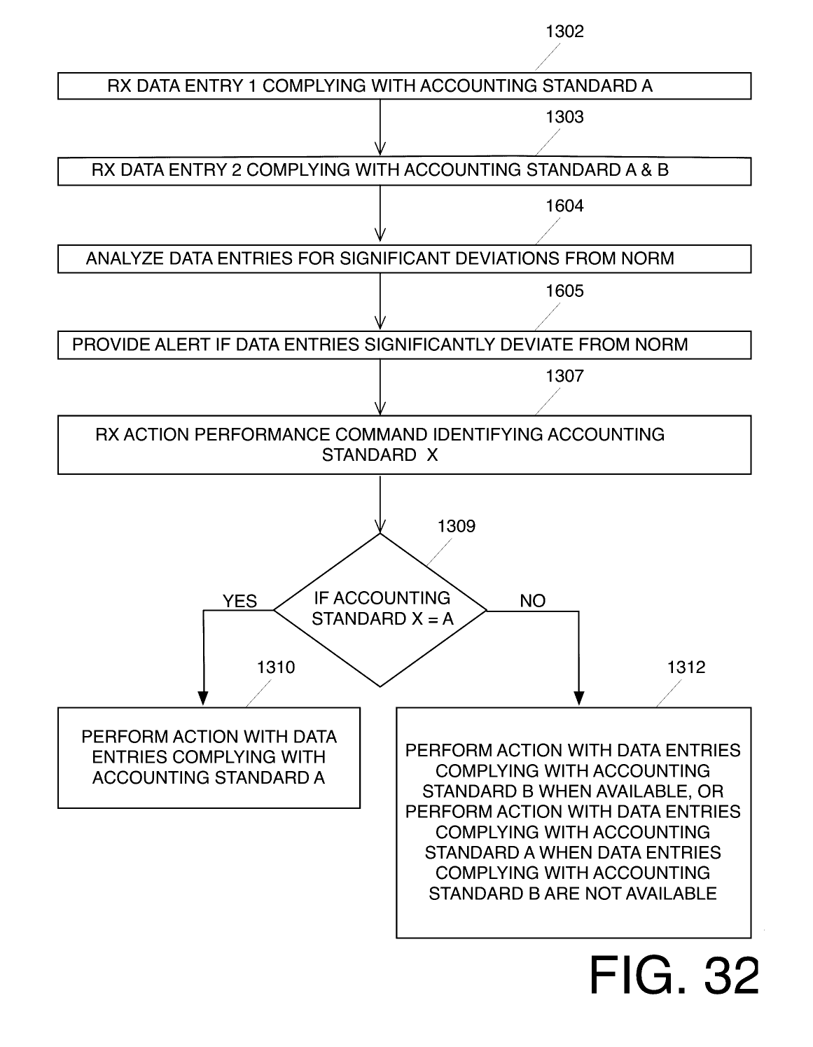

FIG. 32 is a flowchart diagram illustrating actions that may be implemented in some embodiments of the computerized accounting information system, or that may be included within a method of processing accounting data. Specifically, FIG. 32 is the flowchart diagram of FIG. 29 with additional actions.

As is described above, because data entries may be analyzed for significant deviations from what would be expected as a consistent data entry under a particular accounting standard, it is possible to infer/extrapolate/compute this expected data entry based, at least in part, on a sample of related and relevant data entries under similar transactions, or under similar sub-fields across a variety of transactions. Therefore, as is illustrated in FIG. 32, the data entries are analyzed for significant deviations from an expected data entry based, at least in part, on at least one of a group comprising the type of data field, the “A” accounting standard and the “B” accounting standard (1604). If the data entries significantly deviate from the expected data entry, an alert indicator is provided (1605). Processing of the action may then be halted until the situation is remedied, or the action may continue and the computerized accounting information system may simply flag the data entry as potentially suspect.

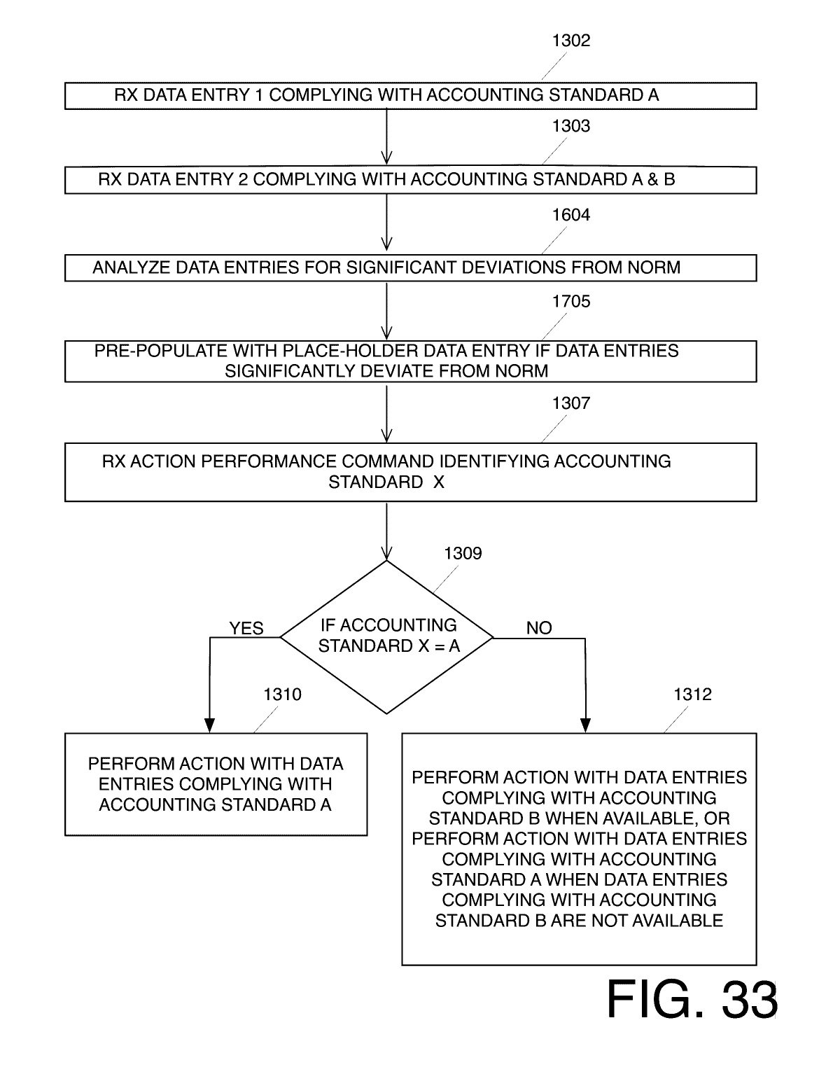

FIG. 33 is a flowchart diagram illustrating actions that may be implemented by the various embodiments of the computerized accounting information system, or that may be included within a method of processing accounting data. Specifically, FIG. 33 is the flowchart diagram of FIG. 32 with an additional action in place of 1605.

As described above, instead of merely providing a significant deviation alert indicator, it may be more helpful to leverage the obtained expected data entry such that a specific data entry value suggestion is provided. Therefore, as is illustrated in FIG. 33, if the data entries significantly deviate from the expected data entry, the type of data field may be prepopulated with a place holder data entry (1705). In another non-limiting embodiment of FIG. 33, the type of data field is not prepopulated, but instead, emphasized with a suggestion indicator allowing for replacement of any previously entered data entry with the suggested place holder data entry (1705). In still another non-limiting embodiment of FIG. 33, the type of data field is only emphasized with a suggestion indicator if the previously entered data entry is sufficiently statistically different from the place holder data entry (1705). One having ordinary skill in the art recognizes that the preceding embodiments are merely some of the possible variations available for leveraging the obtained expected data entry such that a specific data entry value suggestion may be provided. Therefore, the various embodiments are not limited to any particular technique.

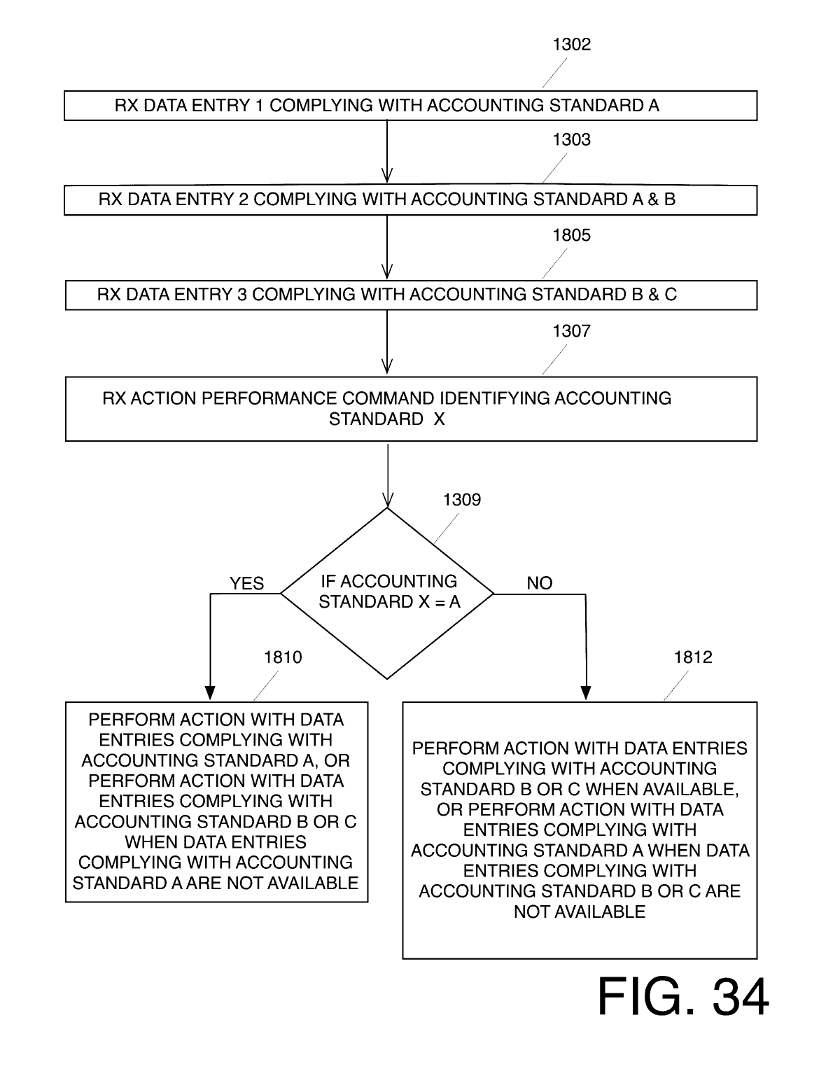

FIG. 34 is a flowchart diagram illustrating actions that may be implemented by the various embodiments of the computerized accounting information system, or that may be included within a method of processing accounting data. Specifically, FIG. 34 is the flowchart diagram of FIG. 29 with additional actions including one in place of 1310 and 1312.

In the illustrated embodiment, a data entry for a third type of data field is received (1805). As is illustrated, this data entry does not comply with the “A” accounting standard; however, it does comply with at least one other accounting standard “B.” Table-7 depicts, as an exemplary embodiment, how received data entries may be compiled and organized for use based on FIG. 34.

TABLE 7

| Data | Accounting Standard | | |
|---|---|---|---|
| Entry ID | A | B | C |
| 1 | XXX | | |
| 2 | YYY | Y′Y′Y′ | |
| 3 | | Z′Z′Z′ | Z″Z″Z″ |

Therefore, Table-7, in contrast to Table 4, depicts, as an exemplary embodiment, that a data entry for the ZZZ type of data field was received, and that this data entry complied with the “B” accounting standard and the “C” accounting standard but not the “A” accounting standard.

After the data has been entered into the system, if the identified accounting standard is the “A” accounting standard (1309), then the action of the command is performed with one or more data entries that comply with the “A” accounting standard, or, if a data entry is needed for performance of the action but it does not comply with the “A” accounting standard, then data entries complying with any of the other accounting standards is used (1810). However, if the identified accounting standard is the “B” accounting standard (1309), then the action of the command is performed with one or more data entries that comply with the “B” accounting standard, if available (1812). If not available, then the action of the command is performed with one or more data entries that comply with the “A” accounting standard for each of the one or more data entries that is unavailable in the “B” accounting standard (1812). If not available, then the action of the command is performed with one or more data entries that comply with the “C” accounting standard for each of the one or more data entries that is unavailable in the “A” accounting standard and the “B” accounting standard (1812). Similarly, if the identified accounting standard is the “C” accounting standard (1309), then the action of the command is performed with one or more data entries that comply with the “C” accounting standard, if available (1812). If not available, then the action of the command is performed with one or more data entries that comply with the “A” accounting standard for each of the one or more data entries that is unavailable in the “C” accounting standard (1812). If not available, then the action of the command is performed with one or more data entries that comply with the “C” accounting standard for each of the one or more data entries that is unavailable in the “A” accounting standard and the “C” accounting standard (1812).

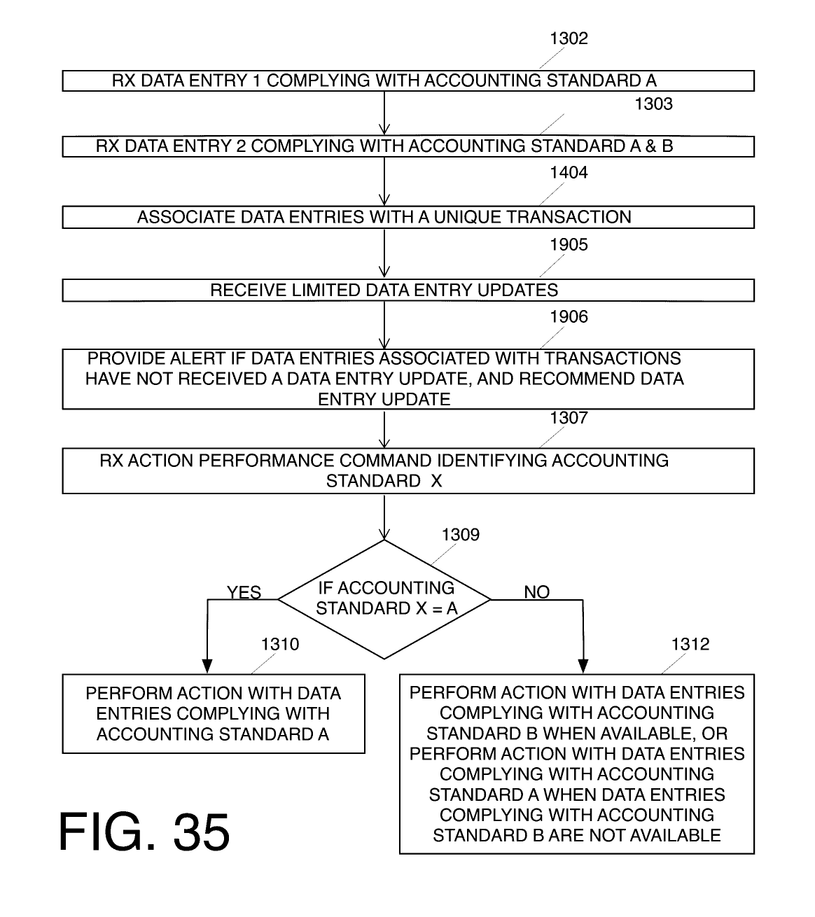

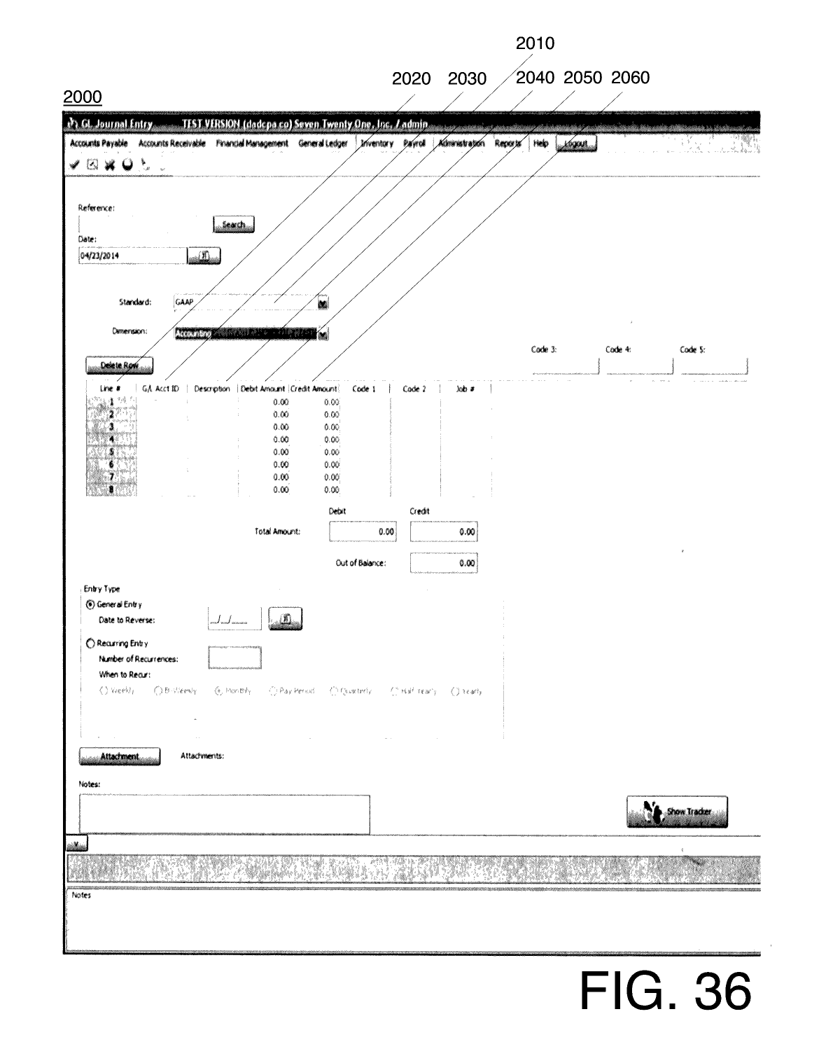

FIG. 35 is a flowchart diagram illustrating actions that may be implemented by the various embodiments of the computerized accounting information system of the present disclosure, or that may be included within a method of processing accounting data. Specifically, FIG. 35 is the flowchart diagram of FIG. 29 with additional actions.

In the illustrated embodiment, at least one limited data entry update for one of the previously received data entries is received (1905). The limited data entry updates may comply only with the default accounting standard, “A,” of the previously received data entries or may comply with the “B” accounting standard. These limited data entry updates may fully update an entire unique transaction for either the “A” accounting standard or the “B” accounting standard. On the other hand, these limited data entry updates may simply update sub-components of the unique transactions for either the “A” accounting standard or the “B” accounting standard. Therefore, if any sub-component data entries associated with a unique transaction, or if any entire unique transaction data entry, has not been updated for either the “A” accounting standard or the “B” accounting standard, an alert indicator is provided that recommends further data entry updates (1906). Processing of the action may then be halted until the situation is remedied, or the action may continue and the computerized accounting information system may simply flag the data entry as potentially suspect.

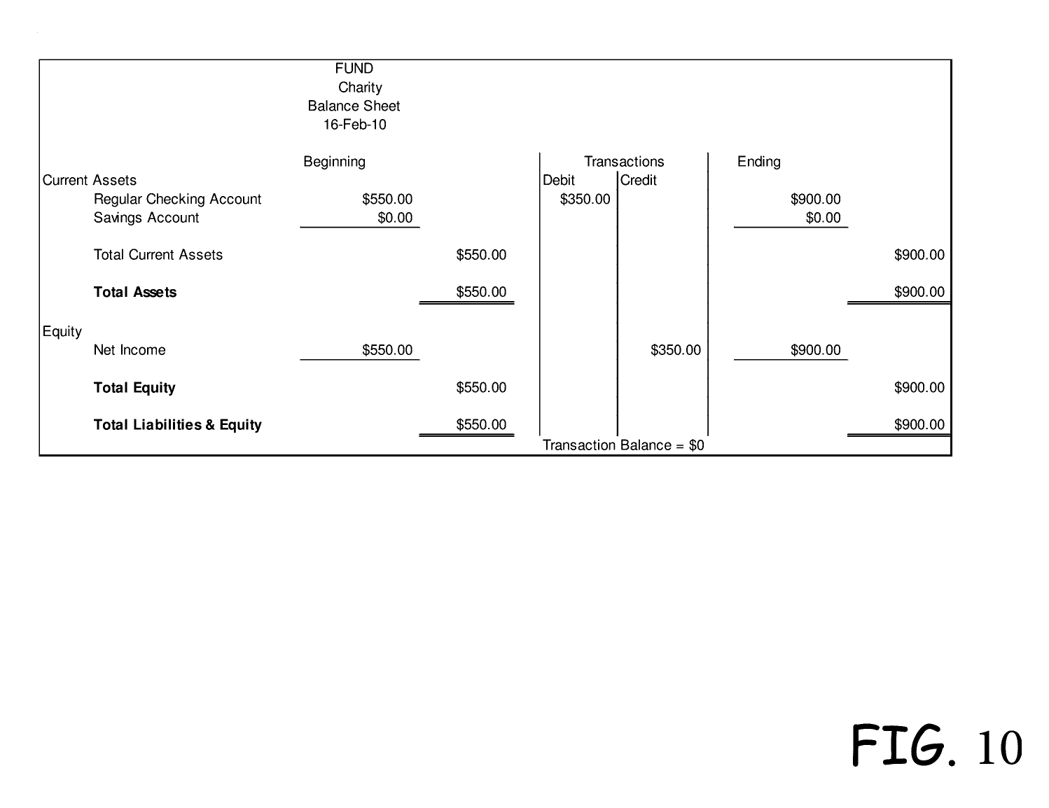

FIG. 10 is a partial view of an exemplary screen structure of an end-user interface selected from many available screen structures in a computerized accounting information system. The end-user interface 2000 may be incorporated into the data entry module 222, either directly or through the network 220, to receive data entries from the end-user; the data entries to be digitally stored, organized and/or analyzed by computerized accounting information system 200. Therefore, the end-user interface 2000 may appear on the end-user platform 205, as described in FIG. 2, when the end-user platform remotely accesses the data entry module 222 hosted on the platform 100 (e.g., as an online application stored in the cloud, or as a webpage stored on a remote server). The end-user interface 2000 may also appear on the end-user platform 205, as described in FIG. 2, because the data entry module 222 is implemented on the end-user platform 205 as a packaged software bundle, or any downloadable piece of software known to one having ordinary skill in the art. Of course, it is envisioned that the end-user interface 2000 may take various different organizational, graphical and design forms.

In one exemplary embodiment, the end-user interface 2000 functions, at least in part, as the interface where an end-user enters data entries to be transmitted and received by the data entry module 222 and the processing module 226. The end-user interface 2000 may also function, at least in part, as the interface where an end-user enters a command to be transmitted and received by the command receiving module 224 and the processing module 226. Consequently, the end-user interface 2000 is configured to provide the end-user with the ability to label, categorize and/or organize data entries into fields and to aggregate data entries of different fields into over-arching transactions.

In the illustrated embodiment, the element 2010 represents one exemplary embodiment of a drop down menu wherein an end-user may select the accounting standard by which the data entries are characterized. The element 2020 represents one column for differentiating the different data entries or the different sub-components of a unique transaction. The element 2030 represents one column for differentiating the different data entries into various unique transactions, or into other grouping categories known to one having ordinary skill in the art. Therefore, the element 2030 represents one embodiment of how a plurality of disparate data entries may be organized and categorized by the end-user. It is with this additional information that the data entries may be leveraged, at least in part, for some of the actions described more thoroughly in FIGS. 29-35.

The element 2040 represents one column for including non-empirical judgment characterization information to be associated and, in certain embodiments, stored with the empirical information that is primarily leveraged by the computerized accounting information system 200. As is described more thoroughly above, financial accounting data may be comprised of empirical information (e.g., monetary values and tax percentages) and non-empirical judgment characterizations related to the accounting standard applied to the accounting data by the end-user. Because an end-user entering data for a specific financial entity must generally follow a specific accounting standard, the same empirical information making up the data entry may be characterized differently by the end-user depending on the particular accounting standard being followed. Therefore, the element 2040 provides an end-user with an information entry point wherein it may record the rational behind the judgment characterizations for each specific data entry under a specific accounting standard at a particular point in time. This may then be readily accessed by the end-user and, in certain embodiments, leveraged by the computerized accounting information system 200 to perform any of the actions described in FIGS. 29-35. As a result, the element 2040 alongside the storing, organizing and analyzing capabilities of the computerized accounting information system 200, may benefits the end-user by substantially eliminating the need for different and discrete business management software records for each accounting standard.

As is understood by one having ordinary skill in the art, the element 2050 and the element 2060 represent standard accounting information data columns for debits and credits to supplant the need for positive and negative integers. Of course, various other columns and organizational elements may be included in the end-user interface 2000. Therefore, the various embodiments are not limited to any particular form or design.

While illustrative embodiments of a computerized accounting information system and a method of processing accounting data have been described in detail herein, it is to be understood that the inventive concepts may be otherwise variously embodied and employed. The appended claims are intended to be construed to include such variations except insofar as limited by the prior art. Possible variations, as described throughout this disclosure, are not to be regarded as a departure from the spirit and scope of the invention. All such possible variations, as would be obvious to one skilled in the art, are intended to be included within the scope of the preceding disclosure and the following claims.

It is understood that any variations of the features of the system and method described in the description section falls within the scope of the invention. There can be many embodiments of this invention as witnessed in some of the figures, and the discussions of them. Not all embodiments of a computerized accounting information system and a method of processing accounting data that would fall within the scope of the claims are necessarily represented here.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In the description and claims the words of the present application, each of “program”, “function” and “module” are used interchangeably. Anything designated as a program, function or module may be a stand-alone entity or a specialized module. A program, function or a module may be modular or have modular aspects allowing it to be easily removed and replaced with another similar unit or module. Each program, function or module may be any one of, or any combination of, software, hardware, and/or firmware. Software of a logical module may be embodied on a computer readable medium such as a read/write hard disc, CDROM, Flash memory, ROM, or other memory or storage, etc. In order to execute a certain task a software program may be loaded to an appropriate processor as needed.

The various embodiments have been described using detailed descriptions of the embodiments, as well as features, aspects, etc. thereof. The various embodiments are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described, and embodiments of the present invention comprising different combinations of features as noted in the described embodiments, will occur to persons with ordinary skill in the art.

It will be appreciated by persons with ordinary skill in the art that the present invention is not limited by what has been particularly shown and described herein above. Rather the scope of the invention is defined by the claims that follow.

What is claimed is:

1. A processor implemented method of securely exchanging data between a first digital general ledger and a second digital general ledger operating on an objected-oriented platform, the method comprising the acts of:
providing an object-oriented application programming interface for a first client-server system and a second client-server system having a common accounting link;
receiving a data input related to a transaction, the transaction necessitating an update to at least a first digital general ledger corresponding to the first client-server system;
associating the update to the first digital general ledger with a second digital general ledger corresponding to the second client-server system;
building a first data transfer object corresponding to the update to the first digital general ledger;
accessing a linking data transfer object corresponding to any data transfer object related to the transaction, the linking data transfer object built by the first client-server system, the second client-server system, or any other system associated with the common accounting link;
linking the first data transfer object to the linking data transfer object;
encrypting the first data transfer object, and restricting access to a corresponding encryption routine, such that access to the first data transfer object is restricted to the first client-server system, the second client-server system, and to any other client-server system associated with the update to the first digital general ledger;
alerting the second client-server system of the first data transfer object;
transmitting the first data transfer object such that the second digital general ledger can be updated based at least in part on the update to the first digital general ledger; and
building a second data transfer object corresponding to an update to the second digital general ledger, based at least in part on the update to the first digital general ledger, and referencing the first data transfer object;
wherein, the first data transfer object, the second data transfer object, and the linking data transfer object are each, respectively, configured to operate on the object-oriented application programming interface and to leverage the means specified by the object-oriented application programming interface; and
wherein, the processor implemented method has the proviso that any transmitting of the first data transfer object or second data transfer object, between the first client-server system and the second client-server system does not involve a remote-user connection between the first client-server system or the second client-server system.
